(19) United States
(12) Patent Application Publication
(10) Pub. No.: US 2026/0300066 A1
(43) Pub. Date: Oct. 1, 2026

(54) EMBEDDING BASED ANOMALY DETECTION FOR MACHINE LEARNING MODELS

(71) Applicant: Amazon Technologies, Inc., Seattle, WA (US)

(72) Inventors: Naveen Konrajankuppam Mahavishnu, Austin, TX (US); Narayanaswami Natraj Bharadwaj, Austin, TX (US); Nishith Sinha, Georgetown, TX (US); Vivek Bhadauria, Bothell, WA (US)

(21) Appl. No.: 19/096,305

(22) Filed: Mar. 31, 2025

(51) Int. Cl. G06F 11/07

(52) U.S. Cl. CPC G06F 11/0751; G06F 11/0721

(57) ABSTRACT

Systems and methods are provided to detect anomalous data obtained from and/or to be routed to a machine learning model. A system can receive a first set of data associated with a machine learning model (e.g., an output of and/or an input to the machine learning model). The system can generate an embedding of the first set of data and can compare the embedding with a second set of data based on the first set of data being associated with the machine learning model. The system can determine a manner of processing the first set of data based on comparing the second set of data and the embedding and can process the first set of data according to the manner of processing the first set of data.

### BACKGROUND

Computing systems can implement machine learning models that can generate outputs in response to inputs. Such machine learning models may be trained using training data to output the responses. For example, the machine learning models can be trained such that the machine learning models can generate an output based on an input that was not included within the training data (e.g., a previously unseen input). As the machine learning models can dynamically identify patterns (e.g., based on the training data) and generate outputs based on an input and the identified patterns, the machine learning models may generate outputs that include anomalous data (e.g., offensive outputs, inappropriate outputs, undesirable outputs, unrelated outputs, etc.). Actively monitoring the machine learning models to identify the anomalous data and/or updating the training data to avoid generating the anomalous data can increase resource utilization and can negatively impact the user experience. Further, the use of such a process can be time-consuming and inefficient.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram depicting an illustrative environment in which a model management system can process data obtained from and/or to be routed to machine learning models.

FIG. 2A is a block diagram depicting an illustrative environment in which an anomaly detection module of the model management system of FIG. 1 can identify anomalous data obtained from and/or to be routed to machine learning models.

FIG. 2B is a block diagram depicting an illustrative environment in which a retrieval-augmented generation module of the model management system of FIG. 1 can identify contextual data to be routed to machine learning models.

FIG. 2C is a block diagram depicting an illustrative environment in which an anomaly detection module of the model management system of FIG. 1 can identify anomalous data obtained from and/or to be routed to machine learning models.

FIG. 3 depicts an illustrative routine for detecting anomalous data for machine learning models based on embeddings.

FIG. 4 depicts an illustrative routine for detecting anomalous data for machine learning models using embeddings of the machine learning models.

FIG. 5 depicts an illustrative routine for dynamically adjusting contextual data during an inference process and/or a training process of machine learning models.

FIG. 6 depicts an illustrative routine for identifying filtered contextual data for retrieval-augmented generation for machine learning models.

FIG. 7 depicts a general architecture of a computing device or system providing a model management system that can identify anomalous data obtained from and/or to be routed to machine learning models and can identify contextual data to be routed to the machine learning models.

### DETAILED DESCRIPTION

Generally described, aspects of the present disclosure relate to managing a machine learning model (e.g., managing the output of the machine learning model, the input to the machine learning model, the inference process performed by the machine learning model, etc.). Such a machine learning model may output anomalous data (e.g., based on a particular input, particular training data, etc.) in response to an input from a user computing device. For example, the machine learning model may output anomalous data (e.g., that may be unintended) that may include offensive outputs (e.g., slurs, affronts, abusive language, offensive images, etc.), inappropriate outputs (e.g., an output discussing the benefits and/or encouraging performance of an illegal, wrong, and/or harmful activity such as murder, driving while intoxicated, etc., an output that includes copyrighted material and/or personal identifying information, etc.), undesirable outputs (e.g., an output that is not desirable for a particular machine learning model such as a machine learning model for code generation providing an output that includes medical advice), unrelated outputs (e.g., an output that is not related to a given input such as an output that includes an image in response to an input requesting code generation), etc. In such scenarios, a system may obtain the anomalous data and provide the anomalous data to a user computing device. As the anomalous data may include offensive outputs, inappropriate outputs, undesirable outputs, unrelated outputs, etc., providing the anomalous data to the user computing device may be undesirable and may cause an ineffective and/or inadequate user experience.

One approach to managing the machine learning model is to modify (e.g., increase) the training data used to train the machine learning model. However, modifying the training data may be relatively expensive and complex. For example, it may be relatively expensive and time consuming to train (and retrain) the machine learning model on large sets of training data (e.g., taking six to nine months to train, test, and/or fine-tune the machine learning model). Further, while modifying the training data may enable the machine learning model to refine and/or define updated patterns between inputs and outputs, such an approach may be susceptible to jailbreaking (e.g., attacks against the machine learning model to cause the machine learning model to output anomalous data by adjusting a prompt, for example, to include text associated with multiple languages, by including hidden payloads within input images, etc.) such that the machine learning model may be periodically retrained which may increase the cost and complexity and decrease the efficiency of such a process.

Another approach to managing the machine learning model is to use static filters (e.g., regular expression filters) to filter the input to and/or the output of the machine learning model. For examples, systems may use classification models, static rules, and/or keyword matching to identify and filter anomalous data from an input and/or an output. However, using static filters in this manner may cause a system to identify false positives and/or false negatives (e.g., falsely identifying an anomalous output as not including anomalous data), may cause the system to implement inconsistent decisions with regard to filtering the input to and/or the output of the machine learning model, and/or may cause the system to hallucinate. For example, a non-anomalous output that includes a keyword linked to anomalous data (e.g., “off” which may be flagged as a variation of kill) may be filtered. Further, while using such static filters may enable a system to identify data previously classified as anomalous data, the use of such static filters may not enable a system to identify data that has not been previously classified as anomalous data (e.g., previously unseen anomalous data) or data that is anomalous data based on the context of the anomalous data (e.g., context-specific anomalous data). For example, such a system may not filter inputs that use different vernaculars, idioms, jargon, etc. for keywords that have been previously recognized as anomalous data (e.g., “sus” for suspicious, “cheugy” or “ohio” for uncool, etc.). In another example, such a system may not filter inputs differently based on the context of the inputs (e.g., the system may filter “kill” regardless of whether “kill” is used in the context of an engine or a person). Therefore, such a system may result in a machine learning model outputting anomalous data and/or blocking non-anomalous data which may be undesirable and may cause an ineffective user experience.

Some systems may provide, as part of a prompt, data to the machine learning model that defines anomalous data and enables the machine learning model to identify and filter the anomalous data. However, providing this data as part of the prompt to the machine learning model may lead to several problems. Specifically, as the size of a prompt may be limited and as increasing amounts of anomalous data are identified (e.g., variations of anomalous data), the number of tokens available for defining the prompt may be decreased which may limit the usefulness of such machine learning models. Further, such a prompt may dramatically increase the resource utilization and/or decrease the efficiency of the machine learning model.

Another approach to managing the machine learning model is to provide contextual data (e.g., contextual data that the machine learning model may not be trained on and/or may not be trained to identify) to the machine learning model with an input. For example, systems may use retrieval-augmented generation to obtain an input for a machine learning model, identify contextual data based on the input, and provide the contextual data with the input to the machine learning model. The machine learning model may generate an output based on the input to the machine learning model. However, while such a process may be used to identify contextual data relevant to an input based on initial contextual needs of the machine learning model (e.g., prior to initiation of an inference process by a machine learning model), such contextual data may not be relevant to intermediary outputs and/or a final output of the machine learning model based on intermediary contextual needs of the machine learning model (e.g., during performance of the inference process). As the provided contextual data may not be relevant to intermediary outputs and/or a final output of the machine learning model (e.g., the contextual data may be outdated, irrelevant, etc.), such outputs may include anomalous data that may not be related to the input (e.g., an incorrect, incomplete, or a less thorough answer than desired to a question). Therefore, such a system may result in a machine learning model outputting anomalous data which may be undesirable and may cause an ineffective user experience.

By providing such anomalous data, a system may cause substantial issues (e.g., for systems and/or users utilizing the output). Such issues may be cascading (cumulative) issues and/or may reduce the functionality of the system (e.g., in that users'trust in the system may be eroded) which may result in an undesirable user experience. For example, the issues may cumulatively grow as the machine learning model generates an output and provides the output (e.g., to other machine learning models).

Embodiments of the present disclosure address these problems by providing for the dynamic management of machine learning models in such scenarios without requiring retraining of the machine learning model and/or extensive sets of training data. Specifically, embodiments of the present disclosure enable a model management system to identify anomalous data associated with a machine learning model (e.g., anomalous data within an input to and/or an output of the machine learning model) and process the anomalous data (e.g., filter the anomalous data). For example, the model management system can use embeddings of the data associated with the machine learning model (e.g., embeddings generated by the machine learning model, embeddings generated by a separate machine learning model, etc.). Embodiments of the present disclosure further enable a model management system to dynamically identify a need of the machine learning model for contextual data during an inference process and/or a training process of the machine learning model and provide the contextual data to the machine learning model in a dynamic manner. For example, the model management system can identify a need for contextual data based on tokens generated by the machine learning model and one or more parameters and can provide the contextual data to the machine learning model by integrating the contextual data with contextual data initially provided to the machine learning model (e.g., with a prompt).

In order to manage implementation of the machine learning model, the model management system can obtain an input from a user computing device. The input may include a request to implement a machine learning model to perform a task (e.g., answer a question, generate code, perform logical reasoning, generate text data, generate image data, solve a problem, make a decision, identify a pattern, etc.). For example, the input may be and/or may include “Please generate a 500 word biography of George Washington.”

Based on the obtained input, the model management system can generate a prompt for the machine learning model. For example, the model management system can perform prompt engineering to generate the prompt. In some cases, the input may include the prompt and the model management system may receive the prompt via the input.

In some cases, the model management system may perform retrieval-augmented generation based on the input and/or the prompt. For example, the model management system may identify a need for contextual data based on the input and/or the prompt (e.g., based on the input including a request to generate a biography of George Washington) and may perform retrieval-augmented generation to obtain the contextual data based on identifying the need for contextual data. To perform the retrieval-augmented generation, the model management system may obtain the contextual data from a data store (e.g., a remote or external data store). The model management system may provide the contextual data to the machine learning model. For example, the model management system may add the contextual data to the input and/or the prompt.

The model management system may provide (e.g., via a model router) the prompt (e.g., the prompt and the contextual data) to a computing system implementing the machine learning model. In some cases, the model management system and the machine learning model may be implemented by the same computing system and the model management system may provide the input directly to the machine learning model. In some cases, the model management system and the machine learning model may be implemented by different systems. For example, a first computing system may implement the model management system and a second computing system, remote from the first computing system, may implement the machine learning model.

Based on providing the prompt to the computing system, the machine learning model may generate an output (e.g., a response to the prompt) based on performance of an inference process and/or a training process by the machine learning model. The model management system may obtain (e.g., via a model router) the output from the computing system and may route the output to the user computing device.

In a first example, to enable the identification of anomalous data, the model management system may generate an embedding (e.g., a vector embedding) of data associated with the machine learning model (e.g., an input to and/or an output of the machine learning model) and may compare the embedding with other embeddings.

To determine whether the data associated with the machine learning model corresponds to anomalous data, the model management system can process the data (e.g., to align the data, filter the data, etc.) and can generate an embedding of the aligned data using an embedding model. For example, the model management system can identify an input to the machine learning model and generate an embedding, using an embedding model, of the input based on determining the input is an input for a machine learning model.

The model management system can obtain a set of data (e.g., a set of anomalous data) based on the input. For example, the set of data may include one or more embeddings associated with the machine learning model and identified as anomalous data.

Based on generating the embedding and obtaining the set of data, the model management system can compare the embedding with the one or more embeddings of the set of data. For example, the system can compare the embedding with the one or more embeddings using a vector similarity search. Based on the comparison, the model management system may identify a difference between the embedding and the set of data and compare the difference to a threshold (e.g., a threshold value, a threshold range, etc.).

Based on comparing the difference to the threshold and determining whether the difference satisfies the threshold, the model management system may determine whether the embedding corresponds to anomalous data and may determine a manner of processing data associated with the machine learning model. For example, where the data associated with the machine learning model is an input to the machine learning model, the model management system may determine to filter the input, block the input from being routed to the machine learning model, drop the input, etc. based on determining that the embedding corresponds to anomalous data. In another example, where the data associated with the machine learning model is an output of the machine learning model, the model management system may determine to filter the output, block the output from being routed to a user computing device, drop the output, etc. based on determining that the embedding corresponds to anomalous data. In another example, the model management system may determine to terminate, pause, etc. operation of the machine learning model and/or generate an alert based on determining that the embedding corresponds to anomalous data. In another example, where the data associated with the machine learning model is an input to the machine learning model, the model management system may determine to route the input to the machine learning model based on determining that the embedding does not correspond to anomalous data. In another example, where the data associated with the machine learning model is an output of the machine learning model, the model management system may route the output to a user computing device based on determining that the embedding does not correspond to anomalous data.

By identifying anomalous data in such a manner, the model management system may identify anomalous data that may not correspond to previously identified anomalous data (e.g., previously unseen anomalous data, anomalous data that may not be included within the set of data, etc.) without retraining the machine learning model and/or increasing the amount of training data. Further, the use of such embeddings may be less susceptible to false positives, false negatives, inconsistent decision making, hallucinations, etc. as compared to the use of classification models, static rules, and/or keyword matching. Instead, the model management system may use the embedding generated by the machine learning model to identify anomalous data that may have been previously unseen by the model management system.

In a second example, to enable the identification of anomalous data, the model management system may obtain an embedding (e.g., a vector embedding) generated based on the prompt and may compare the embedding with other embeddings. In some cases, the machine learning model may generate the embedding (e.g., using an embedding model) based on the prompt and the model management system may obtain the embedding directly from the machine learning model. In some cases, the model management system may generate the embedding using an embedding model that is the same (e.g., same type, same version, same size, same algorithm, same competencies, etc.) as the embedding model used by the machine learning model.

In order to identify whether the embedding corresponds to anomalous data, as discussed herein, the model management system may obtain (e.g., from data store) a set of data (e.g., a set of anomalous data) associated with the machine learning model. For example, the set of data may include a plurality of embeddings (e.g., generated by the embedding model). In some cases, the plurality of embeddings may correspond to anomalous data or non-anomalous data. In some cases, the set of data may be machine learning model specific in that the set of data includes embeddings generated by the particular machine learning model.

The model management system may compare (e.g., a vector similarity search) the embedding with the set of data (e.g., the plurality of embeddings), identify a difference between the embedding and the set of data based on the comparison, and compare the difference to a threshold (e.g., a threshold value, a threshold range, etc.) to identify anomalous data.

Based on comparing the difference to the threshold and determining whether the difference satisfies the threshold, the model management system may determine whether the embedding corresponds to anomalous data and may determine a manner of processing data associated with the machine learning model. For example, the model management system may determine to filter, block, drop, etc. an input to the machine learning model and/or an output of the machine learning model based on determining that the embedding corresponds to anomalous data. In another example, the model management system may determine to terminate, pause, etc. operation of the machine learning model and/or generate an alert based on determining that the embedding corresponds to anomalous data. In another example, the model management system may determine to continue operation of the machine learning model and/or generate an alert based on determining that the embedding does not correspond to anomalous data.

By identifying anomalous data using such an embedding, the model management system may identify anomalous data that may not correspond to previously identified anomalous data (e.g., previously unseen anomalous data) without retraining the machine learning model and/or increasing the amount of training data. Further, the use of such embeddings may be less susceptible to false positives, false negatives, inconsistent decision making, hallucinations, etc. as compared to the use of classification models, static rules, and/or keyword matching. Instead, because the embedding may be generated using the same embedding model as the embedding model of the machine learning model (e.g., generated using the embedding model of the machine learning model), the model management system may use the embedding generated by the machine learning model to identify anomalous data that may have been previously unseen by the model management system.

In a third example, to decrease the amount of anomalous data output by the machine learning model, the model management system may provide additional contextual data (e.g., a grammar such as a code language grammar) to the machine learning model during the inference process and/or the training process of the machine learning model. To identify the additional contextual data to provide to the machine learning model, the model management system can obtain a token (e.g., a data unit, a text string, etc.) from the machine learning model in real time (e.g., within milliseconds of the generation of the token by the machine learning model). For example, the machine learning model may generate a plurality of tokens (e.g., a token stream, a data stream, etc.) as part of an inference process and/or a training process and the model management system can obtain a token directly from the machine learning model. The machine learning model may generate the token based on the implementation of the machine learning model according to the prompt and first contextual data (e.g., contextual data provided with the prompt).

In order to determine whether to provide additional contextual data to the machine learning model, the model management system can identify one or more parameters (e.g., associated with the machine learning model, a user, etc.). For example, the one or more parameters may be based on one or more of a numbers of tokens generated by the machine learning model, a time period (e.g., a time period between obtaining additional contextual data), a term, a modification to semantics, a modification to complexity, a background condition, or a contextual gap (e.g., based on a comparison of previously provided contextual data with contextual data that is available to be provided).

The model management system may compare the token to the one or more parameters and determine whether the token satisfies (e.g., is less than, is within a range of, is greater than, matches, etc.) the one or more parameters. For example, the model management system may compare the token to the one or more parameters to determine whether there is a need for additional contextual data. The token satisfying the one or more parameters may indicate a need for additional contextual data that may not have been identified when the model management system identified contextual data to provide with the prompt. For example, the need for additional contextual data may be identifiable from the token but may not be identifiable from the prompt and/or input.

Based on determining that the token satisfies the one or more parameters (e.g., identifying a need for additional contextual data), the model management system can perform retrieval-augmented generation to obtain second contextual data associated with the token. For example, the model management system may obtain the second contextual data from a data store that is external to the model management system.

Based on obtaining the second contextual data, the model management system may route the second contextual data to the machine learning model. In some cases, the model management system may provide the second contextual data to a computing system implementing the machine learning model. In some cases, the model management system may provide the second contextual data directly to the machine learning model.

Prior to routing the second contextual data to the machine learning model, the model management system may integrate the second contextual data with the first contextual data. For example, the model management system may filter out at least a portion of the first contextual data and replace the filtered at least a portion of the first contextual data with the second contextual data. In another example, the model management system (e.g., using an attention mechanism) may weight (e.g., score) the first contextual data with a first weight and may weight the second contextual data with a second weight (e.g., that is greater than the first weight). By integrating the second contextual data with the first contextual data, the model management system can filter irrelevant and/or outdated contextual data while retaining contextual data that may be useful for the machine learning model.

By obtaining second contextual data and integrating the second contextual data with the first contextual data in such a manner, the model management system may increase the amount and/or quality of contextual data provided to the machine learning model. In one example, by using one or more parameters to determine a need for contextual data instead of a strictly binary decision (e.g., obtain contextual data if the confidence of a token is below a threshold), the model management can more proactively and dynamically identify a need for contextual data. Further, by increasing the amount and/or quality of contextual data provided to the machine learning model, the model management system can increase the likelihood that the machine learning model does not generate anomalous data. Instead, the machine learning model may use the second contextual data and the at least a portion of the first contextual data to generate an output that the machine learning model may not have generated using the first contextual data alone.

As used herein, the term “prompt” may refer to any input provided to a machine learning model. The prompt may include information in various modalities (e.g., text, image, video, etc.) or multimodal information. The output of the machine learning model may include information in various modalities or multimodal information. The modalities of information in the response may be different from the modalities of information in the prompt.

It will be understood that while reference may be made herein to a machine learning model, the techniques may be applied to any model. For example, a model may include any computer-based model of any type and of any level of complexity, such as any type of sequential, functional, or concurrent model. In another example, a model may include any type of computational model, such as, for example, recursion models, graph network models, neural network models, language models (e.g., large language models), artificial intelligence models, machine learning models, multimodal models (e.g., models or combinations of models that can accept inputs of multiple modalities, such as images and text), encoder-decoder models, encoder-only models (e.g., auto-encoders), decoder-only models (e.g., autoregressive models), and/or the like. In some cases, the model may include, for example, attention-based and/or transformer architecture or functionality. In some cases, the model may include a neural network trained using self-supervised learning (e.g., trained using noisy data).

Various aspects of the disclosure will be described with regard to certain examples and embodiments, which are intended to illustrate but not limit the disclosure. Although aspects of some embodiments described in the disclosure will focus, for the purpose of illustration, on particular examples of object types, object formats, and the like, the examples are illustrative only and are not intended to be limiting. In some embodiments, the techniques described herein may be applied to additional or alternative types of data and the like. Additionally, any feature used in any embodiment described herein may be used in any combination with any other feature or in any other embodiment, without limitation.

As will be appreciated by one of skill in the art in light of the present disclosure, the embodiments disclosed herein improve the ability of computing systems to manage machine learning models. Moreover, the presently disclosed embodiments address technical problems inherent within machine learning models; specifically, the difficulties of managing inputs to and/or outputs of machine learning models. These technical problems are addressed by the various technical solutions described herein, including the use of embeddings to detect anomalous data and the provision of contextual data to a machine learning model during an inference process and/or a training process. Thus, the present disclosure represents an improvement on existing computing systems in general.

The foregoing aspects and many of the attendant advantages of this disclosure will become more readily appreciated as the same become better understood by reference to the following description, when taken in conjunction with the accompanying drawings.

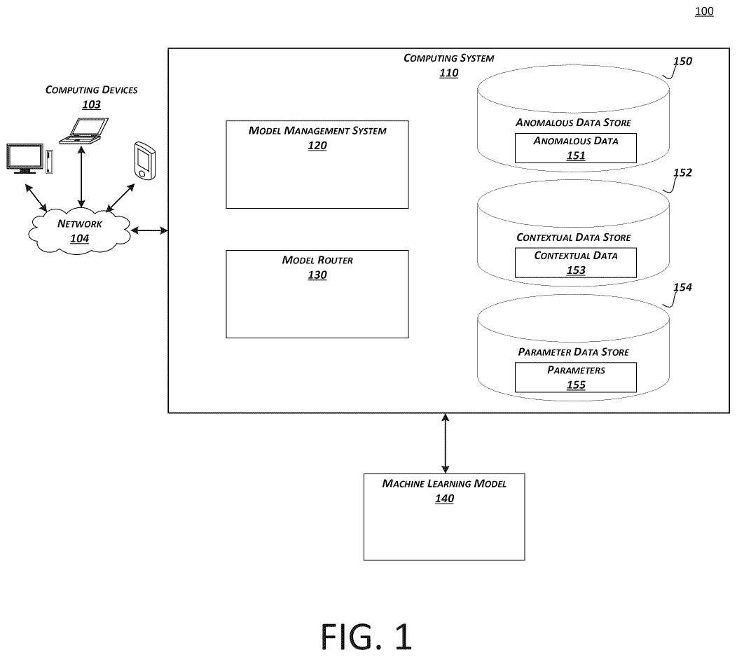

FIG. 1 is a block diagram of an illustrative operating environment 100 in which computing devices 103, a computing system 110, and a machine learning model 140 may interact via a physical connection or a via a network 104. The computing system 110 may include and/or may utilize a plurality of connections with computing devices 103 and/or the machine learning model 140.

In the example of FIG. 1, the computing system 110 includes a model management system 120, a model router 130, an anomalous data store 150 (e.g., a document database such as DocumentDB) storing anomalous data 151 (e.g., embeddings of anomalous data, vector angles associated with anomalous data, vector offsets associated with anomalous data, etc.), a contextual data store 152 storing contextual data 153, and a parameter data store 154 storing parameters 155. In some cases, one or more of the model management system 120, the model router 130, the anomalous data store 150, the contextual data store 152, or the parameter data store 154 may not be implemented by the computing system 110 and/or may be implemented by a separate system.

In some cases, the computing system 110 (or a separate system) may implement multiple model management systems 120, multiple model routers 130, multiple anomalous data stores 150, multiple contextual data stores 152, and/or multiple parameter data stores 154. For example, the model management system 120 and/or the contextual data store 152 may correspond to (e.g., may be implemented using) distributed architectures such that contextual data retrieval operations may be distributed across multiple contextual data stores 152 and/or multiple model management systems 120 (e.g., multiple nodes of the model management system 120) that may operate in parallel and/or within a same time period. For example, a system may load balance contextual data retrieval operations between multiple model management systems 120 and/or multiple contextual data stores 152 and may aggregate the results from the multiple model management systems 120 and/or multiple contextual data stores 152. In some cases, the computing system 110 may scale (e.g., dynamically scale a number of) the model management system 120, the model router 130, the anomalous data store 150, the contextual data store 152, and/or the parameter data store 154 (e.g., independent of the machine learning model 140). For example, the computing system 110 may dynamically scale up or down the number of model management systems 120, a number of contextual data stores 152, etc. based on a size of a workload associated with the machine learning model 140 (e.g., an amount of contextual data to be queried and/or retrieved).

The anomalous data 151 may include data that has been flagged as offensive, inappropriate, undesirable, unrelated, etc. In some cases, the anomalous data 151 may include one or more embeddings (e.g., vector embeddings) indicative of anomalies. For example, the computing system 110 (or a separate system) may generate the one or more embeddings using an embedding model that is trained to output an embedding as a vector representation (e.g., a vector of 50, 75, 100, etc. dimensions) that represents the anomalous data. The embedding model may be trained such that embeddings of more semantically similar data (e.g., apple and banana as types of fruit, football and soccer as sports, murder and advice on how to commit tax fraud as anomalous data, etc.) are closer together in an embedding space as compared to embeddings of less semantically similar data (e.g., an apple and a referee, murder and chess, etc.).

In some cases, the computing system 110 (or a separate system) may periodically or aperiodically update the anomalous data 151. For example, the computing system 110 may add data to the anomalous data 151 in response to a user flagging the data as anomalous.

In some cases, the computing system 110 and/or the machine learning model 140 may generate all or a portion of the anomalous data 151. The computing system 110 may prompt the machine learning model 140 to generate the anomalous data 151 by requesting the machine learning model 140 generate a number of variations of particular anomalous data, may receive the anomalous data 151 from the machine learning model 140, and may add the anomalous data 151 to the anomalous data store 150. For example, the computing system 110 may provide a prompt to the machine learning model 140 that indicates “Please generate 10 different requests for an entity to commit a crime.”

The contextual data 153 may include data that may provide additional context to the machine learning model 140. For example, the contextual data 153 may include data that was not included within the training data used to train the machine learning model 140. In some cases, the computing system 110 (or a separate system) may periodically or aperiodically update the contextual data 153. In some cases, the computing system 110 (or a separate system) may perform a web crawl to obtain the contextual data 153. In some cases, the contextual data store 152 may correspond to a public data source (e.g., a public website).

The parameters 155 may include one or more parameters indicating a threshold. For example, the parameters 155 may indicate a threshold difference in contextual data 153 (e.g., a threshold difference in the contextual data 153 provided to the machine learning model 140 as compared to the contextual data 153 stored by the contextual data store 152), a threshold time period (e.g., a threshold time period for performance of an inference process by the machine learning model 140), a threshold number of tokens (e.g., a threshold number of tokens generated by the machine learning model 140), or threshold data included within a particular token (e.g., a threshold term or phrase (e.g., whether a token includes a particular term), a threshold modification to the semantics (e.g., whether the semantics of the output of the machine learning model 140 have changed in a particular manner), the modification to the complexity (e.g., whether the complexity of the output of the machine learning model 140 has changed in a particular manner), or a background condition (e.g., a threshold background knowledge condition for generating an output).

By way of illustration, various example computing devices 103 are shown in communication with the computing system 110, including a desktop computer, laptop, and a mobile phone. In general, the computing devices 103 can be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like.

The computing system 110 may provide the computing devices 103 with one or more user interfaces, command-line interfaces (CLI), application programing interfaces (API), and/or other programmatic interfaces for providing an input to the computing system 110 (e.g., defining a prompt for the machine learning model 140).

In some cases, the computing system 110 may implement the machine learning model 140. For example, the computing system 110 may implement the machine learning model 140 using resources (e.g., memory, data processing hardware, etc.) of the computing system 110.

In some cases, the machine learning model 140 may be implemented by a separate computing system (e.g., a second computing system). While the machine learning model 140 may be implemented by a separate computing system, the machine learning model 140 may be implemented in response to an input (e.g., a prompt, instructions, etc.) from the computing system 110.

In order to implement the machine learning model 140, the computing system 110 (or the separate computing system) may perform operations including identifying (e.g., loading) a weight (e.g., a series of weights) associated with (e.g., defined according to) the machine learning model 140, obtaining an input, modifying the input using the weight (e.g., according to an architecture of the machine learning model 140), and generating an output based on modifying the input. The computing system 110 may perform the operations using computing system resources (e.g., memory, processing units, network interfaces, etc.).

The computing devices 103, the computing system 110, and/or the machine learning model 140 may communicate via a network 104, which may include any wired network, wireless network, or combination thereof. For example, the network 104 may be a personal area network, local area network, wide area network, over-the-air broadcast network (e.g., for radio or television), cable network, satellite network, cellular telephone network, or combination thereof. As a further example, the network 104 may be a publicly accessible network of linked networks, possibly operated by various distinct parties, such as the Internet. In some embodiments, the network 104 may be a private or semi-private network, such as a corporate or university intranet. The network 104 may include one or more wireless networks, such as a Global System for Mobile Communications (GSM) network, a Code Division Multiple Access (CDMA) network, a Long Term Evolution (LTE) network, or any other type of wireless network. The network 104 can use protocols and components for communicating via the Internet or any of the other aforementioned types of networks. For example, the protocols used by the network 104 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

In FIG. 1, the computing devices 103 may provide an input to the computing system 110. The input may include a request for implementation of the machine learning model 140. For example, the input may include a request to implement a machine learning model to answer a question, generate code, perform logical reasoning, generate text data, generate image data, solve a problem, make a decision, identify a pattern, etc.

Based on receiving the input, the computing system 110 may generate a prompt (e.g., a machine learning model prompt) for the machine learning model 140. For example, the computing system 110 may perform prompt engineering to generate the prompt. The computing system 110 may perform prompt engineering by reformatting the input (e.g., into a format associated with the machine learning model 140), rephrasing the input, adjusting the input (e.g., adjusting a length of the input, splitting the input into multiple inputs, adjusting a style, choice of words, or grammar of the input, etc.), adding contextual data (e.g., via retrieval-augmented generation), etc.

As discussed herein, to generate the prompt, the model management system 120 may perform retrieval-augmented generation. To perform the retrieval-augmented generation, the model management system 120 may identify and/or obtain initial contextual data, from the contextual data stored in the contextual data store 152, for inclusion within the prompt and/or to provide with the prompt. To identify and/or obtain the initial contextual data, the model management system 120 may review the prompt and/or the input, identify at least a portion of the prompt and/or the input indicates a need for contextual data, and automatically obtain the initial contextual data, from the contextual data store 152, that is associated with at least a portion of the prompt and/or the input (e.g., by reviewing and/or parsing the contextual data 153 that is stored in the contextual data store 152). In some cases, to obtain the contextual data, the model management system 120 may identify an embedding (e.g., a multi-model embedding) associated with the prompt (e.g., included within the prompt), may compare the embedding to an embedding of the contextual data 153, and may identify the contextual data based on comparing the embedding to the embedding of the contextual data 153. In one example, the input may indicate “Write a set of code according to a series of parameters in the code language F #,” Based on the input indicating “the code language F #,” the model management system 120 may obtain initial contextual data associated with “the code language F #” (e.g., a code library, code functions, code modules, code definitions, etc. associated with the code language F #).

Based on performing the retrieval-augmented generation, the model management system 120 may generate an augmented prompt (e.g., a prompt that includes the initial contextual data). For example, the model management system 120 may dynamically insert the initial contextual data within the generated prompt.

In some cases, the model management system 120 may obtain an embedding of the prompt (e.g., the augmented prompt and/or the non-augmented prompt) and/or the input. For example, the embedding may be a representation (e.g., a numerical representation) of the prompt and/or the input in an embedding space (e.g., a latent space).

In some cases, the model management system 120 may implement an embedding model and may generate the embedding (e.g., an embedding vector that encodes non-numerical data as a vector of numbers). For example, the model management system 120 may identify an embedding model implemented by the machine learning model 140 and may implement a same embedding model to generate the embedding (e.g., a same version of embedding model, a same type of embedding model, etc.).

In some cases, the model management system 120 may obtain the embedding from a separate and/or distinct embedding model. For example, the model management system 120 may obtain the embedding from an embedding model implemented by the machine learning model 140.

In some cases, the model management system 120 may align (e.g., segment, chunk, etc.) the prompt and/or the input and may obtain an embedding of the aligned prompt and/or the aligned input.

The model management system 120 may compare the embedding with the anomalous data 151. For example, the model management system 120 may compare the embedding with one or more embeddings of the anomalous data 151 (e.g., using a vector similarity search).

Based on comparing the embedding with the anomalous data 151, the model management system 120 may determine a difference between the embedding and the anomalous data 151 and may compare the difference to a threshold to determine whether the difference satisfies the threshold. For example, the difference may be a spatial difference between the embedding and the anomalous data 151 within the embedding space.

Based on comparing the embedding with the anomalous data 151 (e.g., and determining whether the difference between the embedding and the anomalous data 151 satisfies the threshold), the model management system 120 may determine a manner of processing the input and/or the prompt. For example, based on determining the difference satisfies the threshold, the model management system 120 may drop the input, may filter the input, may not route the input to the machine learning model 140, may generate an alert, may terminate operation of the machine learning model 140, etc. In another example, based on determining the difference does not satisfy the threshold, the model management system 120 may route the input to the machine learning model 140.

Based on generating the prompt (e.g., the augmented prompt) and/or determining that the embedding does not satisfy one or more parameters, the model management system 120 may route the generated prompt the machine learning model 140.

Based on routing the generated prompt to the machine learning model 140, the machine learning model 140 may perform an inference process and/or a training process. For example, the inference process may include the process of the machine learning model 140 receiving an input and generating an output. In another example, the training process may include the process of training the machine learning model 140 to generate a particular output given a particular input. Based on performance of the inference process and/or the training process, the machine learning model 140 may generate a token and/or an embedding. For example, the machine learning model 140 may generate a token as an output of the machine learning model 140. In another example, the machine learning model 140 may generate an embedding (e.g., using the embedding model).

In some cases, the model management system 120 may obtain a token and/or an embedding generated by the machine learning model 140. For example, the model management system 120 may obtain the token and/or the embedding from the machine learning model 140 in real time (e.g., within milliseconds of the generation of the token and/or the embedding by the machine learning model 140). In some cases, the model management system 120 may pull the token and/or the embedding directly from the machine learning model 140 (e.g., from the machine learning model stack).

In some cases, the model management system 120 may compare the token obtained from the machine learning model 140 with the parameters 155. Based on comparing the token obtained from the machine learning model 140 with the parameters 155, the model management system 120 may determine whether the token satisfies the parameters 155 (e.g., based on a threshold difference in contextual data, a threshold time period, a threshold number of tokens, or threshold data included within a particular token as indicated by the parameters 155). For example, based on determining the token satisfies the parameters 155, the model management system 120 may identify a need for additional contextual data. In another example, based on determining that the token does not satisfy the parameters 155, the model management system 120 may identify there is no need for additional contextual data.

Based on determining that the token satisfies the parameters 155 (e.g., and identifying a need for additional contextual data), the model management system 120 may identify and/or obtain the additional contextual data from the contextual data store 152. For example, based on a particular token satisfying the parameters 155, the model management system 120 may identify additional contextual data that is associated with the token (e.g., that includes all or a portion of the token, that is related to all or a portion of the token, etc.). In some cases, to obtain the additional contextual data, the model management system 120 may identify an embedding associated with the token (e.g., generated by the machine learning model 140), may compare the embedding to an embedding of the contextual data 153, and may identify the additional contextual data based on comparing the embedding to the embedding of the contextual data 153. For example, the model management system 120 may identify the additional contextual data using cosine similarity.

In order to improve a quality of an output of the machine learning model 140 and/or to decrease a likelihood that the machine learning model 140 outputs anomalous data, the model management system 120 may provide the additional contextual data to the machine learning model 140. In some cases, to provide the additional contextual data, the model management system 120 may provide the additional contextual data with at least a portion of the initial contextual data.

As discussed herein, the model management system 120 may compare the embedding generated by and obtained from the machine learning model 140 with the anomalous data 151. Based on comparing the embedding with the anomalous data 151, the model management system 120 may determine a difference between the embedding and the anomalous data 151 and may compare the difference to a threshold to determine whether the difference satisfies the threshold.

Based on comparing the embedding with the anomalous data 151 (e.g., and determining whether the difference between the embedding and the anomalous data 151 satisfies the threshold), the model management system 120 may determine a manner of processing data associated with the machine learning model 140. For example, based on determining the difference satisfies the threshold, the model management system 120 may drop an input to and/or an output of the machine learning model 140, may filter the input and/or the output, may not route the input to the machine learning model 140, may not route the output to the computing devices 103, may generate an alert, may terminate operation of the machine learning model 140, etc. In another example, based on determining the difference does not satisfy the threshold, the model management system 120 may route the input to the machine learning model 140, may route the output to the computing devices 103, etc.

The model management system 120 may obtain an output from the machine learning model 140. In some cases, the machine learning model 140 may generate the output based on at least a portion of the initial contextual data provided to the machine learning model 140 with the prompt and the additional contextual data provided to the machine learning model 140 during the inference process and/or the training process.

In some cases, the initial contextual data and/or the additional contextual data may include textual data and/or non-textual data. For example, the initial contextual data and/or the additional contextual data may include text data, audio data, graph data, or image data. In some cases, the model management system 120 may combine (e.g., integrate) textual data of the contextual data with non-textual data of the contextual data. For example, the model management system 120 may transform (e.g., normalize, reformat, adjust a format of, etc.) the textual data and/or the non-textual data (e.g., into a format supported by, compatible with, etc. the machine learning model 140). In some cases, the model management system 120 may identify a need for non-textual contextual data. For example, the model management system 120 may identify a need for and may obtain non-textual contextual data from the contextual data store 152 based on determining that the token satisfies the parameters 155.

Based on obtaining the output from the machine learning model 140, the model management system 120 may generate an embedding based on the output. For example, the model management system 120 may generate the embedding using an embedding model of the model management system 120. In some cases, the model management system 120 may obtain an embedding of the output from the machine learning model 140.

As discussed herein, the model management system 120 may compare the embedding with the anomalous data 151. Based on comparing the embedding with the anomalous data 151, the model management system 120 may determine a difference between the embedding and the anomalous data 151 and may compare the difference to a threshold to determine whether the difference satisfies the threshold.

Based on comparing the embedding with the anomalous data 151 (e.g., and determining whether the difference between the embedding and the anomalous data 151 satisfies the threshold), the model management system 120 may determine a manner of processing the output. For example, based on determining the difference satisfies the threshold, the model management system 120 may drop the output, may filter the output, may not route the output to the computing devices 103, may generate an alert, may terminate operation of the machine learning model 140, etc. In another example, based on determining the difference does not satisfy the threshold, the model management system 120 may route the output to the computing devices 103.

In some cases, the model management system 120 may continuously update (e.g., refine) the anomalous data 151, the contextual data 153, the parameters 155, the threshold, etc. as the model management system 120 performs anomaly detection. For example, the model management system 120 may update the anomalous data 151 based on classifying particular data as anomalous data, may update the parameters 155 based on an output of the machine learning model 140, etc.

In some cases, the model management system 120 may include, may be, and/or may be implemented as a cloud provider network that can be accessed by the computing devices 103 over the network 104. A cloud provider network (e.g., a “cloud”) may be and/or may include a pool of network-accessible computing resources (such as compute, storage, and networking resources, applications, and services) which may be virtualized or bare-metal. The cloud provider network can provide convenient, on-demand network access to a shared pool of configurable computing resources that can be programmatically and/or dynamically provisioned and released in response to customer commands (e.g., to adjust to variable load).

The cloud provider network may implement various computing resources and/or services, which may include a virtual compute service, a data processing service (e.g., map reduce, data flow, and/or other large scale data processing techniques), a data storage service (e.g., object storage service, block-based storage service, or data warehouse storage service), domain name service (“DNS”), relational database service, and/or any other type of network based service (which may include various other types of storage, processing, analysis, communication, event handling, visualization, and security services not illustrated).

Such resources and/or services may correspond to various configurations of computing devices, including computational resources (e.g., processors, such as central processing units (CPUs), graphical processing units (GPUs), machine learning accelerators, or the like) and storage resources (e.g., random access memory, persistent storage of various configurations, etc.). For example, a cloud provider network may provide resources in the form of virtual machine instances on a compute service, virtual storage drives on a block storage service, and object storage locations object storage service. Servers may implement such resources and/or services using hardware computer memory and/or processors, an operating system that provides executable program instructions for the general administration and operation of that server, and/or a computer-readable medium storing instructions that, when executed by a processor of the server, allow the server to perform its intended functions. The resources and/or services may implement one or more user interfaces (including graphical user interfaces (GUIs), command line interfaces (CLIs), application programming interfaces (APIs)) enabling the computing devices 103 to access and configure resources provided by the various resources and/or services.

In one example, the cloud provider network can provide on-demand, scalable computing environments (e.g., “virtual computing devices”) to users. Such computing environments may have attributes of a personal computing device including hardware (e.g., various types of processors, local memory, random access memory (“RAM”), hard-disk and/or solid state drive (“SSD”) storage, etc.), a choice of operating systems, networking capabilities, and pre-loaded application software. Such computing environments may virtualize a console input and output (“I/O”) (e.g., keyboard, display, and mouse) which may enable users to connect to the environment using a computer application such as a browser, application programming interface, software development kit, etc. in order to configure and/or use the virtual computing device. In some cases, the hardware associated with the virtual computing devices can be scaled up or down.

In some cases, the cloud provider network may be formed as a number of regions (e.g., separate geographical areas). A region may be connected to a global network (e.g., private networking infrastructure that connects a region to another region). A region may include two or more availability zones (e.g., an availability zone, a domain, a failure domain, etc.) that are connected via a network, isolated, and/or include separate facilities (e.g., separate power, separate networking, and/or separate cooling). Users may connect to availability zones via a network (e.g., the Internet, a cellular communication network) by way of a transit center (TC) that links users to the cloud provider network. The TC may be collocated at other network provider facilities (e.g., Internet service providers, telecommunications providers) and may be securely connected (e.g., via a VPN or direct connection) to the availability zones. The cloud provider network may deliver content from a location outside of, but networked with, a region (e.g., using edge locations and/or regional edge cache servers). This compartmentalization and geographic distribution of computing hardware can enable the cloud provider network to provide low-latency resource access to users on a global scale with a high degree of fault tolerance and stability.

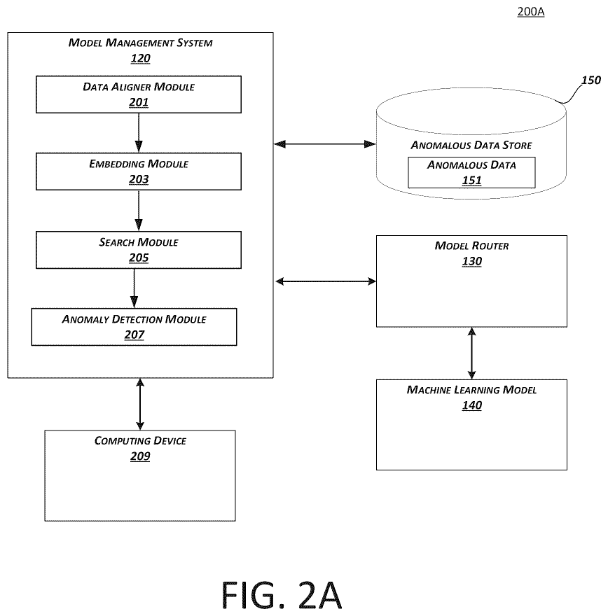

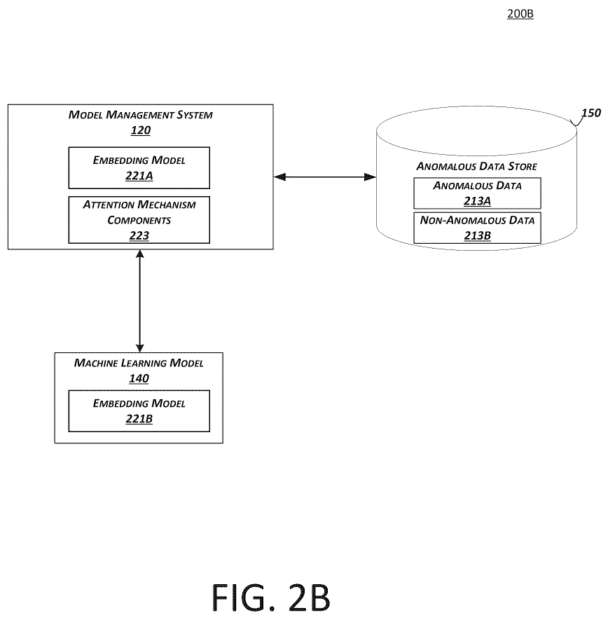

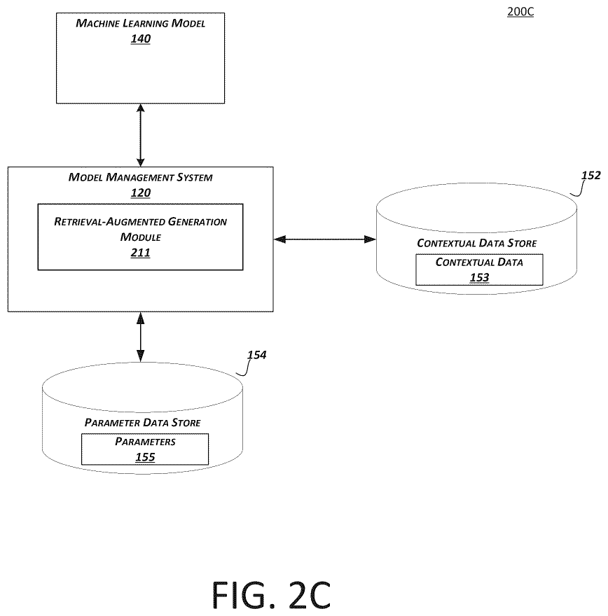

To illustrate how the model management system 120 may utilize embeddings to identify anomalous data within an input to and/or an output from a machine learning model, FIG. 2A is a block diagram of an illustrative operating environment 200A in which the model management system 120 operates (e.g., the model management system 120 discussed herein with reference to FIG. 1) and is in communication with the anomalous data store 150 (e.g., the anomalous data store 150 discussed herein with reference to FIG. 1), the model router 130 (e.g., the model router 130 discussed herein with reference to FIG. 1), computing device 209 (e.g., the user computing devices 103 discussed herein with reference to FIG. 1), and the machine learning model 140 (e.g., the machine learning model 140 discussed herein with reference to FIG. 1). The model management system 120 may route an input to and/or obtain an output from the machine learning model 140 using the model router 130 (e.g., may route an input to and/or obtain an output from the model router 130). In some cases, the model management system 120 may use separate processors (e.g., separate routers) for routing inputs to and obtaining outputs from the machine learning model 140. As shown in FIG. 2A, the model management system 120 includes and implements a data aligner module 201, an embedding module 203, a search module 205, and an anomaly detection module 207. It will be understood that the model management system 120 may include more, less, or different components and/or modules. For example, the model management system 120 may not include a data aligner module. In some cases, a separate system or a separate component (e.g., a separate component of the model management system 120) may include and/or may implement one or more of data aligner module 201, the embedding module 203, the search module 205, or the anomaly detection module 207.

As discussed herein, in the example of FIG. 2A, the anomalous data store 150 includes anomalous data 151. For example, the anomalous data store 150 may include one or more embeddings representing anomalous data 151. In some cases, the model management system 120 (or a separate system) may update (e.g., continuously and/or automatically) the anomalous data 151.

As discussed herein, the model management system 120 may identify data associated with a machine learning model 140. For example, the model management system 120 may identify an input from the computing device 209 (e.g., for generation of a prompt for the machine learning model 140) and/or may obtain an output from the machine learning model 140 via the model router 130 (e.g., for routing to the computing device 209). In another example, the model management system 120 may generate a prompt to be routed to the machine learning model 140 via the model router 130.

The model management system 120 may determine that the data (e.g., the input, the output, the prompt, etc.) is associated with the machine learning model 140. For example, the model management system 120 may determine that the data includes an output of the machine learning model 140, an input to the machine learning model 140, etc. In another example, the model management system 120 may determine that the data is associated with the machine learning model 140 based on obtaining the data from the model router 130 and/or determining that the data is to be routed to the model router 130.

In order to avoid providing potentially anomalous data (e.g., potentially harmful data, potentially adversarial data, etc.) to the machine learning model 140 and/or the computing device 209, in response to determining that the data is associated with the machine learning model 140 (e.g., is an output of and/or an input to a machine learning model 140), the model management system 120 may determine whether the data corresponds to the anomalous data 151.

Based on determining that the data is associated with the machine learning model 140, the model management system 120 may determine how to process the data based on a determination of whether the data corresponds to anomalous data 151. To determine whether the data corresponds to the anomalous data 151, the data aligner module 201 may align the data to obtain aligned data. To align the data, the data aligner module 201 may process (e.g., reformat, normalize, standardize, etc.) the data. For example, the data aligner module 201 may adjust a length of the data, a type of the data, etc. In some cases, the data aligner module 201 may identify a format (e.g., a data format) of the anomalous data 151 and may reformat the data such that the format of the data matches the format of the anomalous data 151.

Based on the aligned data, the embedding module 203 may generate an embedding (e.g., a vector, a vector embedding, etc.). For example, the embedding module 203 may convert the aligned data to an embedding (e.g., using an embedding model, a machine learning model, etc.). In some cases, the embedding module 203 may be, may include, and/or may implement GloVe models, fastText models, Word2vec models, ELMo models, principal composition analysis models, singular value decomposition models, BERT models, or other embedding modelling methods.

The embedding may include a representation (e.g., a value, a numerical value, a vector of numbers, etc.) for all or a portion of the aligned data. For example, the embedding may represent a given word or token of the aligned data. The value of the embedding may further include, represent, or otherwise be associated with one or more features of the aligned data learned by the embedding module 203 during training.

In order to determine whether the data corresponds to anomalous data, the search module 205 may obtain the anomalous data 151 from the anomalous data store 150 and may compare the generated embedding to the anomalous data 151. In some cases, the search module 205 may compare the generated embedding to one or more embeddings of the anomalous data 151. For example, to compare the generated embedding to the anomalous data 151, the search module 205 may perform a vector search (e.g., a vector similarity search), may determine an embedding distance and/or embedding difference (e.g., a cosine distance, an L2-norm (a Euclidean distance), an L1-norm (a Manhattan distance), a Gower distance, a Minkowski distance, etc.), may determine a cosine similarity, etc. In some cases, the search module 205 may determine a distance (e.g., a cluster distance) between the embedding and one or more clusters of the anomalous data 151 (e.g., as clustered by the model management system 120). For example, the distance may be a distance between the embedding one or more centroids (e.g., one or more centers) of the one or more clusters.

In some cases, to compare the generated embedding to the anomalous data 151, the search module 205 may determine a difference (e.g., a numerical difference, a similarity score, etc.) between the generated embedding and the anomalous data 151, may compare the difference to a threshold (e.g., a threshold associated with the anomalous data 151 such as 0.7, 0.8, 0.85, etc.), and may determine whether the difference satisfies the threshold. In some cases, to compare the generated embedding to the anomalous data 151, the search module 205 may determine a plurality of differences between the generated embedding and different portions of the anomalous data 151, may compare the plurality of differences to a threshold, and may determine whether all or a portion of the plurality of differences satisfy the threshold.

Based on comparing the generated embedding to the anomalous data 151, the anomaly detection module 207 may determine whether the generated embedding (and the corresponding data) corresponds to the anomalous data 151. For example, the anomaly detection module 207 may determine that the generated embedding corresponds to the anomalous data 151 (e.g., includes the anomalous data 151 and/or a variation of the anomalous data 151, is likely to include the anomalous data 151 and/or a variation of the anomalous data 151, etc.) based on determining that the difference satisfies the threshold (e.g., a difference of the plurality of differences satisfies the threshold). In another example, the anomaly detection module 207 may determine that the generated embedding does not correspond to the anomalous data 151 (e.g., does not include the anomalous data 151 and/or a variation of the anomalous data 151, is not likely to include the anomalous data 151 and/or a variation of the anomalous data 151, etc.) based on determining that the difference does not satisfy the threshold (e.g., that the plurality of differences do not satisfy the threshold).

In response to determining that the generated embedding corresponds to the anomalous data 151, the model management system 120 may drop, filter, etc. the corresponding data. For example, where the data corresponds to an input to the machine learning model 140, the model management system may drop (e.g., discard) the input and may not route the input to the machine learning model 140. In another example, where the data corresponds to an output of a machine learning model 140 generated in response to an input from the computing device 209, the model management system may drop the output and may not route the output to the computing device 209. In some cases, the model management system 120 may generate an alert (e.g., indicating that the data corresponds to anomalous data, indicating a similarity or a rate of similarity between the data and the anomalous data, indicating a reliability of the data, etc.) and cause display of the alert at t the computing device 209 (e.g., the computing device 209 providing the input associated with the data). In some cases, the model management system 120 may retrigger the machine learning model 140. For example, where the data corresponds to an output of a machine learning model 140 generated in response to an input from the computing device 209, the model management system may drop the output and provide the input (or a different input) back to the machine learning model 140.

In response to determining that the generated embedding does not correspond to the anomalous data 151, the model management system 120 may route the corresponding data to a data destination. For example, in response to determining that the generated embedding does not correspond to the anomalous data 151, the model management system 120 may route an input for a machine learning model 140 that corresponds to the embedding to the machine learning model 140 and/or may route an output of the machine learning model 140 that corresponds to the embedding to the computing device 209.

In some cases, the model management system 120 may perform the process of FIG. 2A for an input to and/or an output of the machine learning model 140. For example, the model management system 120 may receive, from the computing device 209, an input to a machine learning model 140, determine the input does not correspond to the anomalous data 151 using a first embedding, route the input (or a corresponding prompt) to the machine learning model 140 via the model router 130 based on determining the input does not correspond to the anomalous data 151, obtain an output of the machine learning model 140 via the model router 130 based on routing the input to the machine learning model 140, determine the output does not correspond to the anomalous data 151 using a second embedding, and route the output to the computing device 209 based on determining the output does not correspond to the anomalous data 151.

By using the embedding to identify whether the data associated with the machine learning model 140 includes anomalous data, the model management system 120 can convert multiple, diverse types of data into a unified embedding representation and can enable a consistent evaluation across different modalities (e.g., an image, text, audio, etc.). Further, using such an embedding to identify the anomalous data, may reduce a number of false positives and/or false negatives and/or increase an amount of anomalous data identified by a model management system.

In some cases, the model management system 120 may generate the anomalous data 151. To generate the anomalous data 151, the model management system 120 may obtain data (e.g., raw data) and may determine that the data is anomalous. For example, the computing device 209 may provide data to the model management system 120 and may flag the data as anomalous.

Based on obtaining the data and determining that the data is anomalous, the data aligner module 201 may align the data. For example, the data aligner module 201 may reformat the data from a first format (e.g., a plurality of formats) to a second format (e.g., a standard format, a normalized format, etc.). In some cases, to align the data, the data aligner module 201 may resize image data, video data, etc., compress audio data, etc.

Based on aligning the data, the embedding module 203 may generate one or more embeddings of the aligned data (e.g., using an embedding model). In some cases, the embedding module 203 may use different embedding models to embed the aligned data based on the modality of the data. For example, the embedding module 203 may generate an embedding of aligned audio data using a first embedding module and may generate an embedding of aligned text data using a second embedding module.

In order to use the one or more embeddings to identify anomalous data, the model management system 120 may store the one or more embeddings in the anomalous data store 150 as anomalous data 151.

In some cases, the model management system 120 may periodically or aperiodically update the anomalous data 151 in the anomalous data store 150. For example, the model management system 120 may update the anomalous data 151 by removing embeddings from and/or adding embeddings to the anomalous data 151. In some cases, based on determining that an embedding corresponds to the anomalous data, the model management system 120 may add the embedding to the anomalous data 151.

In some cases, the model management system 120 may periodically or aperiodically update one or more embedding models used by the embedding module 203. For example, the model management system 120 may periodically retrain the one or more embedding models to adapt to changes in language and/or content patterns.

To illustrate how the model management system 120 may utilize embeddings generated by a machine learning model and/or components associated with an attention mechanism of a machine learning model (e.g., vectors, fields, terms, matrices, etc. generated as part of an attention mechanism) to identify anomalous data and determine how to process an input to and/or an output from a machine learning model, FIG. 2B is a block diagram of an illustrative operating environment 200B in which the model management system 120 operates (e.g., the model management system 120 discussed herein with reference to FIG. 1) and is in communication with the anomalous data store 150 (e.g., the anomalous data store 150 discussed herein with reference to FIG. 1) and the machine learning model 140 (e.g., the machine learning model 140 discussed herein with reference to FIG. 1). As shown in FIG. 2B, the model management system 120 includes and implements the embedding model 221A and the machine learning model 140 include and/or implement the embedding model 221B. It will be understood that the model management system 120 may include more, less, or different components and/or modules. For example, the model management system 120 may not include an embedding model. In some cases, a separate system or a separate component (e.g., a separate component of the model management system 120) may include and/or may implement an embedding model.

In some cases, the model management system 120 may utilize embeddings or attention mechanism components 223 to identify anomalous data. In some cases, the model management system 120 may utilize the embeddings and the attention mechanism components 223 to identify anomalous data. For example, the model management system 120 may implement a multi-layer process by performing anomalous data detection using the embeddings and using the attention mechanism components 223.

The embedding model 221A may correspond to the embedding model 221B. For example, the embedding model 221A and the embedding model 221B may be the same type or version of embedding model, may use the same embedding techniques and/or algorithms, may include the same architecture, etc. In some cases, the model management system 120 may identify the embedding model 221B of the machine learning model 140 (e.g., may identify a type, a version, embedding techniques, etc. of the embedding model 221B) and may spin up an embedding model 221A that corresponds to the embedding model 221B (e.g., is the same type, is the same version, uses the same embedding techniques, etc.). In some cases, the embedding model 221A and the embedding model 221B may be the same embedding model.

In some cases, the embedding model 221A and/or the embedding model 221B may include multiple embedding models. For example, the model management system 120 and/or the machine learning model 140 may implement multiple embedding models. The embedding model 221A and/or the embedding model 221B may be, may include, and/or may implement GloVe models, fastText models, Word2vec models, ELMo models, principal composition analysis models, singular value decomposition models, BERT models, or other embedding models.

The machine learning model 140 may be a multi-modal model. For example, the machine learning model 140 may use and/or receive input that includes audio data, video data, sensor data, textual data, image data, etc. In some cases, the machine learning model 140 may be and/or may include a machine learning model for code generation, question answering, logical reasoning, etc.

As discussed herein, in the example of FIG. 2B, the anomalous data store 150 includes anomalous data 213A (e.g., a non-pass list, a block list, etc.) and non-anomalous data 213B (e.g., a pass list, an allow list, etc.). For example, the anomalous data store 150 may include one or more embeddings representing anomalous data 213A (e.g., that is anomalous for a particular machine learning model) and/or one or more embeddings representing non-anomalous data 213B (e.g., that is not anomalous for a particular machine learning model). In another example, the anomalous data store 150 may include one or more attention mechanism components (e.g., one or more query, key, and/or value vectors) representing anomalous data 213A (e.g., a pattern of vectors and an associated prompt representing anomalous data 213A) and/or one or more attention mechanism components representing non-anomalous data 213B (e.g., a pattern of vectors and an associated prompt representing non-anomalous data 213B).

In some cases, the anomalous data 213A may be machine learning model specific. For example, the anomalous data 213A may be based on a type of the machine learning model 140, a role of the machine learning model 140 (e.g., financial services chat bot), an expected output of the machine learning model 140, etc. Further, the anomalous data 213A may represent data that the machine learning model 140 are not intended to generate. For example, for a particular machine learning model configured as a financial services chat bot, the anomalous data 213A for the machine learning model may include legal advice, construction advice, etc. and non-anomalous data 213B for the machine learning model may include financial advice, a listing of financial services, etc. By configuring the anomalous data 213A as machine learning model specific anomalous data, the model management system 120 can account for differences in machine learning models (e.g., in that one output may be considered anomalous for a first machine learning model, but non-anomalous for a second machine learning model).

As discussed herein, the model management system 120 may obtain an input from a user computing device (e.g., an input for a machine learning model 140). Based on obtaining the input, the model management system 120 may generate a prompt (e.g., corresponding to all or a portion of the input) and route the prompt to the machine learning model 140 and/or the embedding model 221A to determine how to process data associated with the machine learning model 140 (e.g., the input, a corresponding output, etc.). In some cases, the model management system 120 may segment the input, generate the prompt based on the segmented input, and route the prompt to the machine learning model 140 and/or the embedding model 221A.

Based on routing the prompt to the machine learning model 140 and/or the embedding model 221A, the model management system 120 may obtain an embedding. For example, the model management system 120 may obtain the embedding directly from the embedding model 221A. In another example, the model management system 120 may monitor performance of the machine learning model 140 (e.g., the embedding model 221B) and may obtain (e.g., pull) the embedding directly from the machine learning model 140.

In some cases, the embedding model 221A and/or the embedding model 221B may generate multiple embeddings (e.g., based on the prompt) and the model management system may obtain the multiple embeddings. In some cases, the embedding model 221A and/or the embedding model 221B may include multiple embedding models. All or a portion of the multiple embedding models may generate respective embedding (e.g., based on the prompt) and the model management system may obtain the multiple embeddings.

In some cases, the model management system 120 may identify a plurality of embeddings generated by the embedding model 221A and/or the embedding model 221B. The model management system 120 may identify an embedding from the plurality of embeddings based on one or more weights associated with the plurality of embeddings (e.g., using an attention mechanism). For example, the model management system 120 may identify an embedding associated with a highest weight as compared to all or a portion of the weights associated with the other embeddings of the plurality of embeddings.

In some cases, based on routing the prompt to the machine learning model 140, the machine learning model 140 may generate an embedding. The machine learning model 140 may include a multi-layer architecture (e.g., a multi-layer transformer architecture). At all or a portion of the layers (e.g., transformer layers) of the multi-layer architecture, the machine learning model 140 may generate and apply one or more attention mechanism components 223 (e.g., query, key, and value vectors) to the embedding as part of an attention mechanism. For all or a portion of the layers, the model management system 120 may obtain (e.g., extract) one or more attention mechanism components 223 (e.g., vectors) generated by the machine learning model 140 (e.g., for the attention mechanism). Based on the obtained one or more attention mechanism components 223, the model management system 120 may identify relationships between one or more tokens.

In order to determine whether the embedding (e.g., the embeddings) and/or the attention mechanism components 223 correspond to anomalous data and to determine how to process data associated with the machine learning model 140, the model management system 120 may obtain the anomalous data 213A and/or the non-anomalous data 213B from the anomalous data store 150 and may compare the embedding and/or the attention mechanism components 223 to the anomalous data 213A and/or the non-anomalous data 213B. For example, the model management system 120 may compare the embedding to one or more embeddings of the anomalous data 213A and/or the non-anomalous data 213B (e.g., using a vector search, an embedding distance, a cosine similarity, a cluster distance, etc.). In another example, the model management system 120 may compare the attention mechanism components 223 to the anomalous data 213A and/or the non-anomalous data 213B (e.g., one or more vectors). In some cases, the one or more vectors of the anomalous data 213A and/or the non-anomalous data 213 may correspond to attention mechanism components 223 previously generated by the machine learning model 140. In some cases, the one or more vectors of the anomalous data 213A and/or the non-anomalous data 213 may correspond to attention mechanism components 223 previously generated by the machine learning model 140 for the same prompt or a different prompt.

In some cases, to compare the embedding and/or the attention mechanism components 223 to the anomalous data 213A and/or the non-anomalous data 213B, the model management system 120 may determine a difference between the embedding and/or the attention mechanism components 223 and the anomalous data 213A and/or the non-anomalous data 213B, may compare the difference to a threshold (e.g., a threshold associated the anomalous data 213A and/or the non-anomalous data 213B), and may determine whether the difference satisfies the threshold. In some cases, to compare the embedding and/or the attention mechanism components 223 to the anomalous data 213A and/or the non-anomalous data 213B, the model management system 120 may determine a plurality of differences between the embedding and/or the attention mechanism components 223 and different portions of the anomalous data 213A and/or the non-anomalous data 213B, may compare the plurality of differences to a threshold, and may determine whether all or a portion of the plurality of differences satisfy the threshold. For example, the model management system 120 may determine a first difference between the embedding and a first embedding of the anomalous data 213A and/or the non-anomalous data 213B, a second difference between the embedding and a second embedding of the anomalous data 213A and/or the non-anomalous data 213B, etc. The model management system 120 may compare the first difference, the second difference, etc. to a first threshold (e.g., a threshold distance) to determine a number of differences that satisfy the first threshold. The model management system 120 may compare the number of differences to a second threshold (e.g., a threshold number of differences) to determine if the embedding and/or the attention mechanism components 223 correspond to anomalous data. For example, the model management system 120 may determine one difference between the embedding and a respective embedding of the anomalous data 213A satisfies the first threshold, and based on the second threshold being two, the model management system 120 may determine that the embedding does not correspond to anomalous data. In another example, the model management system 120 may determine two differences between the embedding and a respective embedding of the anomalous data 213A satisfy the first threshold, and based on the second threshold being two, the model management system 120 may determine that the generated embedding does correspond to anomalous data.

In some cases, the threshold may be machine learning model specific, anomalous data specific, non-anomalous data specific, etc. For example, different portions of the anomalous data 213A may be associated with different thresholds (e.g., configurable thresholds based on a user input) and the model management system 120 may determine a difference between the embedding and a portion of the anomalous data 213A, may compare the difference to a threshold associated with the portion of the anomalous data 213A, and may determine whether the difference satisfies the threshold. In another example, different portions of the anomalous data 213A may be associated with different weights (e.g., based on a degree of anomality) and the model management system 120 may adjust the threshold for determining whether an embedding corresponds to anomalous data based on the weight. In some cases, the model management system 120 may tune (e.g., self-tune) the thresholds, the weights, etc.

In some cases, the model management system 120 may dynamically update (e.g., tune) the threshold. The model management system 120 may dynamically update, in real-time, the threshold based on a confidence score (e.g., an attention confidence score) of the machine learning model 140. For example, the model management system 120 may dynamically increase the threshold based on a first confidence score and may dynamically decrease the threshold based on a second confidence score that is less than the first confidence score.

Based on comparing the embedding and/or the attention mechanism components 223 to the anomalous data 213A and/or the non-anomalous data 213B, the model management system 120 may determine whether the embedding (and the corresponding data) and/or the attention mechanism components 223 correspond to the anomalous data 213A and/or the non-anomalous data 213B. For example, the model management system 120 may determine that the embedding corresponds to the anomalous data 213A based on determining that the difference satisfies the threshold (e.g., a threshold associated with the anomalous data 213A). In another example, the model management system 120 may determine that the embedding corresponds to the non-anomalous data 213B based on determining that the difference satisfies the threshold (e.g., a threshold associated with the non-anomalous data 213B). In another example, by using the attention mechanism components 223 generated by the machine learning model 140, the model management system 120 may identify patterns associated with the attention mechanism (e.g., a pattern of vectors associated with the same prompt or multiple different prompts), may identify a difference (e.g., a deviation) between a vector and the patterns satisfies a threshold, and may identify the vector as corresponding to anomalous data 213A based on identifying the difference satisfies the threshold. In another example, by using the attention mechanism components 223 generated by the machine learning model 140, the model management system 120 may identify a similarity between attention mechanism components 223 (e.g., a similarity between query vectors and key vectors), may identify that the similarity satisfies a threshold, and may identify the attention mechanism components 223 correspond to anomalous data 213A based on identifying the similarity satisfies the threshold.

In some cases, to determine whether the embedding and/or the attention mechanism components 223 correspond to anomalous data 213A, the model management system 120 may perform one or more comparisons to determine one or more scores, determine a number of the one or more scores that satisfy a first threshold, may determine whether the number of scores satisfy a second threshold, and may determine whether the embedding and/or the attention mechanism components 223 correspond to anomalous data 213A based on determining whether the number of scores satisfy the second threshold. For example, the model management system 120 may compare an embedding to the anomalous data 213A to determine an anomalous embedding score, may compare an embedding to the non-anomalous data 213B to determine a non-anomalous embedding score, may compare a vector to the anomalous data 213A and/or the non-anomalous data 213B to determine an attention drift score and/or a vector similarity score, etc. By using embeddings and/or attention mechanism components 223 to identify anomalous data, the model management system 120 may identify direct and/or semantically similar anomalous data (e.g., using the embeddings) and indirect data manipulations and/or complex data dependencies corresponding to anomalous data (e.g., using the attention mechanism components 223).

In some cases, to determine whether the embedding and/or the attention mechanism components 223 correspond to anomalous data 213A, the model management system 120 may compare the output of multiple models (e.g., multiple embedding models). For example, the model management system 120 may implement a multi-way voting scheme such that the model management system 120 may compare embeddings generated by multiple embedding models to the anomalous data 213A, may determine differences between one or more embeddings and the anomalous data 213A satisfy a first threshold, may compare a number of the one or more embeddings to a second threshold, and may determine whether the embeddings correspond to anomalous data based on comparing the number of the one or more embeddings to the second threshold.

In some cases, in response to determining that the embedding and/or the attention mechanism components 223 correspond to the anomalous data 213A and/or do not correspond to the non-anomalous data 213B, the model management system 120 may drop, filter, etc. an input to the machine learning model 140. For example, the model management system 120 may drop (e.g., discard) the input and may not route the input to the machine learning model 140. In another example, the model management system 120 may filter the input and may route the filtered input to the machine learning model 140.

In some cases, in response to determining that the embedding and/or the attention mechanism components 223 correspond to the anomalous data 213A and/or do not correspond to the non-anomalous data 213B, the model management system 120 may drop, filter, etc. an output of the machine learning model 140. For example, the model management system 120 may drop the output and may not route the output to the user computing device. In another example, the model management system 120 may filter the output and may route the filtered output to a user computing device.

In some cases, in response to determining that the embedding and/or the attention mechanism components 223 correspond to the anomalous data 213A and/or do not correspond to the non-anomalous data 213B, the model management system 120 may generate an alert (e.g., indicating that the data corresponds to anomalous data) and cause display of the alert at the user computing device (e.g., the user computing device providing the input associated with the data).

In some cases, in response to determining that the embedding and/or the attention mechanism components 223 correspond to the anomalous data 213A and/or do not correspond to the non-anomalous data 213B, the model management system 120 may retrigger the machine learning model 140 (e.g., provide the input (or a different input) back to the machine learning model 140).

In response to determining that the embedding and/or the attention mechanism components 223 do not correspond to the anomalous data 213A and/or correspond to the non-anomalous data 213B, the model management system 120 may route corresponding data to a data destination. For example, in response to determining that the embedding does not correspond to the anomalous data 213A and/or does correspond to the non-anomalous data 213B, the model management system 120 may route an input for a machine learning model 140 that corresponds to the embedding to the machine learning model 140 and/or may route an output of the machine learning model 140 that corresponds to the embedding to a user computing device.

As discussed herein, in some cases, the model management system 120 may not implement the embedding model 221A. Instead, the model management system 120 may obtain the embedding directly from the embedding model 221B of the machine learning model 140.

By using the embeddings generated by an embedding model that is the same as the embedding model used by the machine learning model 140 and/or the attention mechanism components 223 generated by the machine learning model 140, the model management system 120 can maintain a level of contextual awareness and/or contextual sensitivity of the machine learning model 140. For example, by using the same embedding model for generation and security, the model management system 120 can more accurately identify anomalous data. Further, using such an embedding and/or vector to identify the anomalous data, may reduce a number of false positives and/or false negatives and/or increase an amount of anomalous data identified by a model management system.

In some cases, the model management system 120 may generate the anomalous data 213A and/or non-anomalous data 213B. To generate the anomalous data 213A and/or the non-anomalous data 213B, the model management system 120 may identify an example of anomalous data and/or non-anomalous data 213B associated with the machine learning model 140, may access the machine learning model 140, and may prompt the machine learning model 140 to provide similar examples. For example, the model management system 120 may determine an example of anomalous data is data that includes “kill or murder someone” and may prompt the machine learning model 140 to “generate 20 phrases that convey the idea of ‘kill or murder someone’, include euphemisms, slang, and common language in your 20 phrases that convey the idea of ‘kill or murder someone’.” In another example, the model management system 120 may determine an example of non-anomalous data 213B is data that includes “we recommend this item based on your recent purchase history” and may prompt the machine learning model 140 to “generate 10 phrases that convey the idea of ‘we recommend this item based on your recent purchase history’.”

Based on the output of the machine learning model 140, the model management system 120 may generate one or more embeddings of the output (e.g., using the embedding model 221A). In order to use the one or more embeddings to identify anomalous data, the model management system 120 may store the one or more embeddings in the anomalous data store 150 as anomalous data 213A and/or as non-anomalous data 213B. In some cases, the model management system 120 may segment (e.g., chunk) the data prior to storing the segmented data as anomalous data 213A and/or as non-anomalous data 213B.

In some cases, the model management system 120 may periodically or aperiodically update the anomalous data 213A and/or the non-anomalous data 213B in the anomalous data store 150. For example, the model management system 120 may update the anomalous data 213A by removing embeddings from and/or adding embeddings to the anomalous data 213A.

In some cases, the model management system 120 may periodically or aperiodically update (e.g., retrain) the embedding model 221A. For example, the model management system 120 may periodically update the embedding model 221A in response to updates to the embedding model 221B.

To illustrate how the model management system 120 may utilize tokens generated by a machine learning model during an inference process and/or a training process to identify additional contextual data to provide to the to the machine learning model, FIG. 2C is a block diagram of an illustrative operating environment 200C in which the model management system 120 operates (e.g., the model management system 120 discussed herein with reference to FIG. 1) and is in communication with the contextual data store 152 (e.g., the contextual data store 152 discussed herein with reference to FIG. 1) and the parameter data store 154 (e.g., the parameter data store 154 discussed herein with reference to FIG. 1) and the machine learning model 140. As shown in FIG. 2C, the model management system 120 includes and implements a retrieval-augmented generation module 211. It will be understood that the model management system 120 may include more, less, or different components and/or modules. For example, the model management system 120 may not include a retrieval-augmented generation module. In some cases, a separate system or a separate component (e.g., a separate component of the model management system 120) may include and/or may implement the retrieval-augmented generation module 211.

As discussed herein, in the example of FIG. 2C, the contextual data store 152 includes contextual data 153 (e.g., textual data, nontextual data, etc.) and the parameter data store 154 includes parameters 155. For example, the contextual data store 152 may include contextual data 153 (e.g., a corpus of text, images, etc.) and the parameter data store 154 may include parameters 155 indicating how to determine a need for the contextual data 153. The contextual data 153 may be multi-domain contextual data (e.g., contextual data from multiple domains). In some cases, the model management system 120 (or a separate system) may update (e.g., continuously and/or automatically) the contextual data 153 and/or the parameters 155.

The parameters 155 may be and/or may indicate a threshold for identifying a need for contextual data. For example, the parameters 155 may be and/or may indicate a threshold difference in contextual data (e.g., a threshold difference in contextual data provided to the machine learning model 140 as compared to the contextual data 153 stored in the contextual data store 152 (e.g., available to be provided to the machine learning model 140)), a threshold time period (e.g., a threshold time period for an inference process and/or a training process of the machine learning model 140), a threshold number of tokens (e.g., a threshold number of tokens generated by the machine learning model 140 during an inference process and/or a training process), or threshold data included within one or more tokens (e.g., a threshold modification of semantics of the one or more tokens, a threshold modification of complexity of the one or more tokens, a threshold background knowledge condition for generating an output, etc.).

As discussed herein, the model management system 120 may obtain an input and generate a prompt for the machine learning model 140. For example, the model management system 120 may obtain an input from a user computing device defining a request (e.g., a question to be answered, logical reasoning to be performed, data to be generated, etc.).

In some cases, to generate the prompt, the retrieval-augmented generation module 211 of the model management system 120 may identify a need for contextual data based on the input, the machine learning model 140, the parameters 155, etc. For example, the retrieval-augmented generation module 211 may identify a need for contextual data based on comparing the input to the parameters 155 (e.g., based on the input satisfying a threshold of the parameters 155). In some cases, the retrieval-augmented generation module 211 may automatically identify a need for contextual data based on obtaining the input. For example, the retrieval-augmented generation module 211 may identify a need for contextual data for all or a portion of the inputs.

Based on identifying the need for contextual data, the retrieval-augmented generation module 211 may obtain first contextual data from the contextual data store 152. For example, the retrieval-augmented generation module 211 may perform retrieval-augmented generation to obtain first contextual data that may include and/or may indicate data that is not included within the input, data that is not included within the training data used to train the machine learning model 140, etc. In some cases, to perform the retrieval-augmented generation, the retrieval-augmented generation module 211 may search the contextual data store 152 (e.g., using a similarity search) based on the input to identify first contextual data associated with the input.

Based on obtaining the first contextual data, the model management system 120 may generate the prompt and provide the prompt to the machine learning model 140. In some cases, the model management system 120 may generate a prompt that includes the at least a portion of the input and the first contextual data. A portion of the prompt may be designated for the first contextual data. For example, the first contextual data may be limited to a particular size or amount (e.g., a particular contextual window). In some cases, the model management system 120 may separately provide the first contextual data and the prompt to the machine learning model 140.

Based on obtaining the prompt from the model management system 120, the machine learning model 140 may perform an inference process and/or the training process. During the performance of the inference process and/or the training process, the machine learning model 140 may generate (e.g., output) one or more tokens for all or a portion of the steps of the inference process and/or the training process. In some cases, the machine learning model 140 may generate a plurality of tokens for a given step of the inference process and/or the training process. For example, for a given step of the inference process, the machine learning model 140 may generate a plurality of tokens (e.g., “for,” “to,” “out,” etc.) indicating a predicted next token of a series of tokens (e.g., “I went”).

In some cases, for all or a portion of the plurality of tokens, the machine learning model 140 may output a corresponding probability (e.g., between 0 and 1). For example, the probability may indicate a likelihood that a corresponding token is and/or should be the next token in the series of tokens.

As the machine learning model performs the inference process and/or the training process, the retrieval-augmented generation module 211 may continuously and proactively determine whether there is a need (e.g., an emerging need) for additional contextual data (e.g., using a trained classifier model). For example, the retrieval-augmented generation module 211 may utilize one or more detections (e.g., one or more triggers) to identify the need for additional contextual data. In some cases, the retrieval-augmented generation module 211 may utilize the output of multiple detections (e.g., corresponding to different types of detection, corresponding to the same detection but with different data and/or different parameters, etc.) to identify the need for additional contextual data. For example, the retrieval-augmented generation module 211 may utilize the output of one or more detections based on a classifier model (e.g., indicating a modification to semantics, a modification to complexity, a background condition, etc.), one or more deterministic detections (e.g., indicating a number of tokens generated, a time period associated with the inference process, etc.), etc. to identify the need for additional contextual data.

In some cases, in order to determine whether there is a need for additional contextual data, the retrieval-augmented generation module 211 may obtain a token (e.g., a plurality of tokens, a stream of tokens, etc.) generated by the machine learning model 140. For example, the retrieval-augmented generation module 211 may obtain (e.g., may pull) the token directly and in real time from the machine learning model stack.

The retrieval-augmented generation module 211 may compare the token to the parameters 155 to determine whether the token satisfies the parameters 155.

In an example of a detection of whether there is a need for additional contextual data, the retrieval-augmented generation module 211 may obtain a first token, determine first semantics (e.g., a formality, a form, a syntax, etc.) associated with the first token, obtain a second token, determine second semantics associated with the second token, determine a modification to the semantics based on the first semantics and the second semantics, and compare the modification to the semantics to a threshold modification to the semantics indicated by the parameters. Based on the modification satisfying the threshold modification, the retrieval-augmented generation module 211 may identify a need for additional contextual data.

In another example of a detection of whether there is a need for additional contextual data, the retrieval-augmented generation module 211 may obtain a first token, determine a first complexity (e.g., a length, a number of syllables, a readability, a familiarity, etc.) associated with the first token, obtain a second token, determine a second complexity associated with the second token, determine a modification to the complexity based on the first complexity and the second complexity, and compare the modification to the complexity to a threshold modification to the complexity indicated by the parameters 155. Based on the modification satisfying the threshold modification, the retrieval-augmented generation module 211 may identify a need for additional contextual data.

In another example of a detection of whether there is a need for additional contextual data, the retrieval-augmented generation module 211 may obtain a token and may identify a background condition (e.g., a background knowledge condition) associated with the token. For example, for the token “George Washington,” the retrieval-augmented generation module 211 may identify, based on the token, a background condition is who George Washington is, when George Washington died, where George Washington lived, etc. The retrieval-augmented generation module 211 may compare the background condition to a threshold background condition indicated by the parameters 155. Based on the background condition satisfying the threshold background condition, the retrieval-augmented generation module 211 may identify a need for additional contextual data.

In another example of a detection of whether there is a need for additional contextual data, the retrieval-augmented generation module 211 may obtain a token and may identify a portion of the token (e.g., a particular term, phrase, etc.). The retrieval-augmented generation module 211 may compare the portion of token to a terms, phrases, etc. indicated by the parameters 155. Based on the portion of token being included within the terms, phrases, etc. indicated by the parameters 155, the retrieval-augmented generation module 211 may identify a need for additional contextual data.

In another example of a detection of whether there is a need for additional contextual data, the retrieval-augmented generation module 211 may determine a time period associated with the inference process and/or the training process (e.g., a time period over which the machine learning model 140 has been performing the inference process such as 1 second, 3 seconds, etc.) based on monitoring performance of the inference process and/or the training process by the machine learning model 140. The retrieval-augmented generation module 211 may compare the time period to a threshold time period indicated by the parameters 155. Based on the time period satisfying the threshold time period, the retrieval-augmented generation module 211 may identify a need for additional contextual data.

In another example of a detection of whether there is a need for additional contextual data, the retrieval-augmented generation module 211 may determine a number of tokens associated with the inference process and/or the training process (e.g., a number of tokens generated by the machine learning model 140 during the inference process such as 10 tokens, 50 tokens, 100 tokens, etc.) based on monitoring performance of the inference process and/or the training process by the machine learning model 140. The retrieval-augmented generation module 211 may compare the number of tokens to a threshold number of tokens indicated by the parameters 155. Based on the number of tokens satisfying the threshold number of tokens, the retrieval-augmented generation module 211 may identify a need for additional contextual data.

In another example of a detection of whether there is a need for additional contextual data, the retrieval-augmented generation module 211 may identify contextual data provided to the machine learning model 140 and contextual data stored in the contextual data store 152 (e.g., contextual data available to be provided to the machine learning model 140). The retrieval-augmented generation module 211 may compare the contextual data provided to the machine learning model 140 and contextual data stored in the contextual data store 152 to identify a contextual data difference (e.g., a percentage of the available contextual data that has been provided to the machine learning model such as 10%, 20%, 30%, etc.). The retrieval-augmented generation module 211 may compare the contextual data difference to a threshold contextual data difference indicated by the parameters 155. Based on the contextual data difference satisfying the threshold contextual data difference, the retrieval-augmented generation module 211 may identify a need for additional contextual data.

In some cases, the retrieval-augmented generation module 211 may utilize the output of multiple detection methods to determine whether there is a need for additional contextual data. For example, the retrieval-augmented generation module 211 may perform a first comparison to compare the number of tokens to a threshold number of tokens indicated by the parameters 155, a second comparison to compare the background condition to a threshold background condition indicated by the parameters 155, a third comparison to compare the modification to the complexity to a threshold modification to the complexity indicated by the parameters 155, etc. In some cases, the retrieval-augmented generation module 211 may determine there is a need for additional contextual data if all or a portion of the multiple detection methods indicate there is a need for additional contextual data (e.g., if all of, if a majority of, if two or more of, etc. the multiple detection methods indicate there is need for additional contextual data).

In some cases, the retrieval-augmented generation module 211 may identify a predicted need for additional contextual data (e.g., a predicted future need). For example, the retrieval-augmented generation module 211 may predict (e.g., anticipate) a future need based on one or more tokens (e.g., a trajectory of the one or more tokens) that may not directly indicate a direct need (e.g., current need) for the contextual data but may indicate a future need for the contextual data. In some cases, the retrieval-augmented generation module 211 may identify the predicted need for additional contextual data based on a probability distribution of tokens (e.g., generated by the retrieval-augmented generation module 211). To predict the need for additional contextual data, the retrieval-augmented generation module 211 may review the one or more tokens and project an inference direction of the machine learning model 140. For example, the retrieval-augmented generation module 211 may review characters output by the machine learning model 140 (e.g., phrases, words, numbers, etc.), may project an inference direction based on the output characters, and may predict the need for additional contextual data (e.g., that the machine learning model 140 may need the additional contextual data in the future) based on the review and projected inference direction (e.g., based on a keyword lookup). In one example, the retrieval-augmented generation module 211 may determine that the tokens include a name of a code language (e.g., the tokens may be “the code language F #,”). While the tokens may not indicate a direct need for the contextual data based on reviewing the tokens (e.g., a token including a name of a code language may not indicate that the machine learning model 140 currently needs contextual data including a code library, a code grammar, etc.), the retrieval-augmented generation module 211 may determine that the machine learning model 140 may provide tokens according to the code language in the future (e.g., may write code) based on the token indicating a name of the code language. Based on this determination, in order to satisfy the predicted future need for the contextual data, the retrieval-augmented generation module 211 may obtain (e.g., pre-fetch) and provide contextual data including a code library, a code grammar, etc. associated with the code language without the tokens indicating a current need for the contextual data (e.g., prior to the machine learning model 140 outputting a token indicating a current need for the contextual data).

In some cases, the retrieval-augmented generation module 211 may identify a need for additional contextual data using one or more detections based on multiple tokens associated with the same step of the inference process and/or the training process (e.g., a first token, a second token, a third token, etc. that are predicted to be a next word in a sentence with a particular probability). In some cases, the retrieval-augmented generation module 211 may identify a need for additional contextual data using one or more detections based on multiple tokens associated with the same step of the inference process and/or the training process and the probabilities associated with the multiple tokens (e.g., and output by the machine learning model 140). For example, to identify a need for additional contextual data, the retrieval-augmented generation module 211 may weight the output of a detection using a first token greater than the output of a detection using a second token based on a probability associated with the first token being greater than a probability associated with the second token).

In response to not identifying a need for additional contextual data, the retrieval-augmented generation module 211 may continue the inference process and/or the training process of the machine learning model 140.

In response to identifying the need for additional contextual data, the retrieval-augmented generation module 211 may obtain second contextual data from the contextual data store 152. To obtain the second contextual data, the retrieval-augmented generation module 211 may generate a query (e.g., based on the token) and may query the contextual data store 152 using the generated query. In some cases, to obtain the second contextual data, the retrieval-augmented generation module 211 may compare (e.g., using a vector comparison) the token (e.g., an embedding of the token) to an embedding of contextual data and may determine that the second contextual data satisfies a threshold based on the comparison.

Based on obtaining the second contextual data, the retrieval-augmented generation module 211 may provide the second contextual data to the machine learning model 140. In some cases, the retrieval-augmented generation module 211 may integrate the second contextual data with at least a portion of the first contextual data previously provided to the machine learning model 140 (e.g., augment the first contextual data with the second contextual data) and may provide the integrated contextual data to the machine learning model 140. For example, the retrieval-augmented generation module 211 may update contextual data for the machine learning model 140 based on the second contextual data and may provide the updated contextual data to the machine learning model 140. To integrate the second contextual data with the at least a portion of the first contextual data, the retrieval-augmented generation module 211 may identify a portion of an input to insert (e.g., inject) the second contextual data (e.g., by identifying a position (e.g., semantic boundaries) within the input for insertion of the second contextual data), may score the contextual data, and/or may identify and filter the first contextual data for integration of the second contextual data with the at least a portion of the first contextual data (e.g., by replacing the portion of the first contextual data with the second contextual data). By integrating the second contextual data in this manner, the retrieval-augmented generation module 211 may reduce a conflict between the second contextual data and the at least a portion of the first contextual data and/or maintain coherency as discussed herein.

In some cases, to identify a portion of an input to insert the second contextual data, the retrieval-augmented generation module 211 may determine the position based on an input to and/or an output of the machine learning model 140. For example, the retrieval-augmented generation module 211 may identify boundaries (e.g., semantic boundaries such as a paragraph break and/or a topic transition) and may insert the second contextual data at the boundaries.

In some cases, to identify a portion of an input to insert the second contextual data, the retrieval-augmented generation module 211 may identify (e.g., may extract) an attention mechanism of the machine learning model 140 (e.g., an attention pattern). Based on the attention mechanism, the retrieval-augmented generation module 211 may identify a portion of the input (e.g., a natural point) to inject the second contextual data. In some cases, the retrieval-augmented generation module 211 may review the input to identify boundaries within the input using an attention mechanism (e.g., based on analyzing attention patterns) of the machine learning model 140.

In some cases, to identify a portion of an input to insert the second contextual data, the retrieval-augmented generation module 211 may group (e.g., cluster) data within the input. For example, the retrieval-augmented generation module 211 may group portions of the input according to a topic of the portion such that related contextual data is grouped together.

In some cases, to identify a portion of an input to insert the second contextual data, the retrieval-augmented generation module 211 may segment portions of the second contextual data and/or the first contextual data and separate the portions (e.g., using one or more tokens). For example, the retrieval-augmented generation module 211 may generate the portions of contextual data and may insert delimiter tokens (e.g., a comma, a semicolon, etc.) between the portions of contextual data in order to indicate to the machine learning model 140 the different portions of contextual data. Based on the inserted delimiter tokens, the machine learning model 140 may differentiate (e.g., distinguish) between different portions of contextual data.

In some cases, to identify a portion of an input to insert the second contextual data, the retrieval-augmented generation module 211 may track (e.g., monitor) contextual data provided to the machine learning model 140. The retrieval-augmented generation module 211 may subsequently identify particular portions of the contextual data for replacement based on tracking the provided contextual data.

In some cases, to score the contextual data, the retrieval-augmented generation module 211 may score the first contextual data and/or the second contextual data (e.g., based on the token). For example, the retrieval-augmented generation module 211 may determine a relevance and/or semantic similarity of the first contextual data and/or the second contextual data to the token and may score the first contextual data and/or the second contextual data based on the relevance and/or the semantic similarity. In some cases, the retrieval-augmented generation module 211 may provide the scores to the machine learning model 140.

In some cases, to score the contextual data, the retrieval-augmented generation module 211 may weight (e.g., rank, etc.) the second contextual data and/or the at least a portion of the first contextual data (e.g., using an attention mechanism). For example, the retrieval-augmented generation module 211 may weight the at least a portion of the first contextual data with a first weight (e.g., a first attention weight) and may weight the second contextual data with a second weight (e.g., a second attention weight) that is greater than the first weight in order to prioritize the second contextual data (e.g., newer contextual data) over the first contextual data (e.g., older contextual data). In another example, the retrieval-augmented generation module 211 may perform term frequency-inverse document frequency based ranking (e.g., a ranking based on rarity) to weight the second contextual data and/or the at least a portion of the first contextual data. In another example, the retrieval-augmented generation module 211 may compare (e.g., using a vector similarity search, a cosine similarity, etc.) the second contextual data and/or the at least a portion of the first contextual data to embeddings generated by and/or outputs of the machine learning model 140, may determine a similarity score (e.g., a relevance score) between the second contextual data and/or the at least a portion of the first contextual data to embeddings generated by and/or outputs of the machine learning model 140, and may weight the second contextual data and/or the at least a portion of the first contextual data based on the similarity score.

In some cases, to filter the first contextual data for integration of the second contextual data with the at least a portion of the first contextual data, the retrieval-augmented generation module 211 may compare the first contextual data and/or the second contextual data (e.g., an embedding of contextual data) with one or more tokens (e.g., an embedding of the one or more tokens) to identify data that is not relevant to the one or more tokens (e.g., contextual data that is or is not included in the one or more tokens). For example, the retrieval-augmented generation module 211 may perform a vector comparison between the one or more tokens and the first contextual data and/or the second contextual data using a vector search, an embedding distance, an embedding difference, etc., may identify a vector associated with at least a portion of the first contextual data and/or the second contextual data satisfies a threshold, and may identify the at least a portion of the first contextual data and/or the second contextual data for filtering.

In some cases, to filter the first contextual data for integration of the second contextual data with the at least a portion of the first contextual data and to identify the at least a portion of the first contextual data and/or the second contextual data for filtering, the retrieval-augmented generation module 211 may compare the first contextual data and/or the second contextual data. The retrieval-augmented generation module 211 may identify a time period, a source, an uncertainty, etc. and may identify contextual data based on the identified time period, source, uncertainty, etc. (e.g., based on comparing the time period, source, uncertainty, etc. to a threshold and/or to other time periods, sources, uncertainties, etc.). For example, the retrieval-augmented generation module 211 may identify contextual data for filtering that is associated with an older time period as compared to other contextual data in order to retain and/or prioritize newer, more recently updated, etc. contextual data. In another example, the retrieval-augmented generation module 211 may identify contextual data for filtering that is associated with a particular uncertainty as compared to other contextual data in order to retain and/or prioritize contextual data associated with a greater level of certainty. In another example, the retrieval-augmented generation module 211 may identify contextual data for filtering that is associated with a particular source as compared to other contextual data in order to retain and/or prioritize contextual data associated with other sources (e.g., more reliable sources as compared to the particular source). In another example, the retrieval-augmented generation module 211 may compare a time period associated with the first contextual data and/or the second contextual data (e.g., a time period since a particular portion of the first contextual data and/or the second contextual data was used by and/or was relevant to an output of the machine learning model 140, a time period since the particular portion of the first contextual data and/or the second contextual data was provided to the machine learning model 140, etc.), may identify a time period associated with at least a portion of the first contextual data and/or the second contextual data satisfies a threshold, and may identify the at least a portion of the first contextual data and/or the second contextual data for filtering in order to retain and/or prioritize particular contextual data (e.g., contextual data that was relevant to an output of the machine learning model 140 more recently as compared to other contextual data). In another example, the retrieval-augmented generation module 211 may compare a number of tokens associated with the first contextual data and/or the second contextual data (e.g., a number of tokens since a particular portion of the first contextual data and/or the second contextual data was used by and/or was relevant to an output of the machine learning model 140, a number of tokens associated with a particular portion of the first contextual data and/or the second contextual data, etc.), may identify a number of tokens associated with at least a portion of the first contextual data and/or the second contextual data satisfies a threshold, and may identify the at least a portion of the first contextual data and/or the second contextual data for filtering in order to retain and/or prioritize particular contextual data.

In some cases, the retrieval-augmented generation module 211 may maintain contextual data for a particular time period (e.g., a retention period) or number of tokens. For example, in response to adding contextual data to an input, the retrieval-augmented generation module 211 may maintain the contextual data for a particular time period and may not remove the contextual data from the input until the time period has passed.

In some cases, to filter the first contextual data for integration of the second contextual data with the at least a portion of the first contextual data, the retrieval-augmented generation module 211 may compare the first contextual data and the second contextual data and may identify a conflict (e.g., a contradiction, a semantic contradiction, an inconsistency, etc.) between the first contextual data and the second contextual data based on the comparison. Based on identifying the conflict, the retrieval-augmented generation module 211 may perform conflict resolution. To perform conflict resolution, the retrieval-augmented generation module 211 may identify for filtering and may filter at least a portion of the first contextual data and/or the second contextual data to remove a conflicting portion of the first contextual data and/or the second contextual data. In some cases, to perform the conflict resolution, the retrieval-augmented generation module 211 may utilize an attention mechanism of the machine learning model 140. For example, the retrieval-augmented generation module 211 may adjust an attention pattern to adjust (e.g., to lower) a weight of all or a portion of conflicting contextual data.

In some cases, to filter the first contextual data for integration of the second contextual data with the at least a portion of the first contextual data, the retrieval-augmented generation module 211 may filter (e.g., prune) the first contextual data and/or the second contextual data based on a size (e.g., a length) of an input for the contextual data (e.g., a contextual window). For example, the retrieval-augmented generation module 211 may filter the first contextual data and/or the second contextual data to remove a portion of the first contextual data and/or the second contextual data such that the filtered contextual data is less than or equal to the size of the input for the contextual data. In some cases, the first contextual data and the second contextual data may be associated with different contextual windows. For example, the retrieval-augmented generation module 211 may filter the first contextual data to remove a portion of the first contextual data such that a size of the first contextual data is less than or equal to a first contextual window associated with the first contextual data and/or the retrieval-augmented generation module 211 may filter the second contextual data to remove a portion of the second contextual data such that a size the second contextual data is less than or equal to a second contextual window associated with the second contextual data. The retrieval-augmented generation module 211 may include the filtered first contextual data and/or the filtered second contextual data within an input.

In some cases, to filter the first contextual data for integration of the second contextual data with the at least a portion of the first contextual data, the retrieval-augmented generation module 211 may filter (e.g., prune) the first contextual data and/or the second contextual data based on the data included within first contextual data and/or the second contextual data in order to preserve access to particular data (e.g., private data, confidential data, sensitive data, etc.). For example, the retrieval-augmented generation module 211 may filter contextual data based on one or more criterion (e.g., authorization criteria) to remove contextual data that is not authorized to be accessed (e.g., private data, healthcare related data, finance related data, etc.). In some cases, the one or more criterion may indicate whether a particular user, device, model, organization, clearance level (e.g., privacy level, security level, etc.) etc. is authorized to access particular data (e.g., based on a tag, a keyword, a label, a flag, a marker, etc. associated with the data). For example, the model management system 120 may obtain an input from a user computing device requesting implementation of the machine learning model 140. Based on the input, the retrieval-augmented generation module 211 may obtain an identifier (e.g., tag, keyword, label, flag, marker, etc.) associated with the user computing device. For example, the identifier may indicate a user, a device, a model, an organization, a privacy level, a security level, etc. associated with the user computing device. Using the one or more criterion and the identifier, the retrieval-augmented generation module 211 may identify data (e.g., data associated with the identifier) that the user computing device is authorized to access and data that the user computing device is not authorized to access. The retrieval-augmented generation module 211 may filter the first contextual data and/or the second contextual data to remove contextual data that the user computing device is not authorized to access. In some cases, the first contextual data and/or the second contextual data may include and/or may be associated with a tag, a keyword, a label, a flag, a marker, etc. associated with the contextual data (e.g., all or a portion of the elements of the contextual data may be associated with different tags) and the retrieval-augmented generation module 211 may identify the portion of the first contextual data and/or the second contextual data based on comparing the tag, the keyword, the label, the flag, the marker, etc. associated with contextual data and the tag, the keyword, the label, the flag, the marker, etc. associated with the user as indicated by the one or more criterion.

In some cases, to filter the first contextual data for integration of the second contextual data with the at least a portion of the first contextual data, the retrieval-augmented generation module 211 may filter the first contextual data and/or the second contextual data prior to obtaining the first contextual data and/or the second contextual data (e.g., from a data store). For example, the retrieval-augmented generation module 211 may filter the first contextual data and/or the second contextual data as stored at the data store and may obtained the filtered first contextual data and/or second contextual data from the data store.

In some cases, to filter the first contextual data for integration of the second contextual data with the at least a portion of the first contextual data, the retrieval-augmented generation module 211 may maintain (e.g., reserve) a portion of the input for base contextual data (e.g., base knowledge, a particular portion of the first contextual data, etc.) and may not overwrite the portion of the input with additional contextual data.

In order to integrate the first contextual data with the input to the machine learning model 140, the retrieval-augmented generation module 211 may score the first contextual data and/or the second contextual data, may filter (e.g., prune) the first contextual data and/or the second contextual data (e.g., to maintain an amount of contextual data within a particular contextual window), and/or may identify how to position the first contextual data and/or the second contextual data within an input. For example, the retrieval-augmented generation module 211 may filter the first contextual data and/or the second contextual data to remove a portion of the first contextual data and/or the second contextual data that has a score, weight, etc. that does not satisfy (e.g., does not match or exceed) a threshold and may identify a portion of an input to insert and integrate the second contextual data with the first contextual data (e.g., as filtered).

In some cases, the retrieval-augmented generation module 211 may cause the machine learning model 140 to drop the token (e.g., the token generated based on the first contextual data for a first inference step) and generate a second token (e.g., based on the second contextual data and at least a portion of the first contextual data for the same first inference step). In some cases, the retrieval-augmented generation module 211 may not cause the machine learning model 140 to drop the token (e.g., the token generated based on the first contextual data for a first inference step) and may cause the machine learning model generate a second token (e.g., based on the second contextual data and at least a portion of the first contextual data for a different second inference step).

In some cases, the retrieval-augmented generation module 211 may continuously and/or automatically identify additional contextual data as the machine learning model 140 performs the inference process and/or the training process. The retrieval-augmented generation module 211 may monitor the process (e.g., the inference process and/or the training process) and/or the contextual data provided to the machine learning model 140.

In some cases, based on the monitoring, the retrieval-augmented generation module 211 may identify a weight applied (e.g., previously) to contextual data. Based on the weight (e.g., based on the weight satisfying a threshold), the retrieval-augmented generation module 211 may maintain (e.g., reserve) a portion of the input for the contextual data and may not overwrite the portion of the input with additional contextual data. Based on the weight (e.g., based on the weight not satisfying a threshold), the retrieval-augmented generation module 211 may identify a portion of the input to be overwritten with additional contextual data.

In some cases, based on the monitoring, the retrieval-augmented generation module 211 may identify a time period associated with the contextual data (e.g., a time period since the contextual data was obtained and/or provided to the machine learning model 140). Based on the time period (e.g., based on the time period satisfying a threshold), the retrieval-augmented generation module 211 may maintain (e.g., reserve) a portion of the input for the contextual data and may not overwrite the portion of the input with additional contextual data. In some cases, the retrieval-augmented generation module 211 may use the time period to identify contextual data to overwrite (e.g., remove). For example, retrieval-augmented generation module 211 may identify the contextual data associated with the longest or oldest time period (e.g., as compared to other contextual data provided to the machine learning model 140) and may overwrite the contextual data with additional contextual data.

By providing the input (e.g., with the second contextual data) to the machine learning model 140, the retrieval-augmented generation module 211 may increase a likelihood that an output generated by the machine learning model 140 does not include anomalous data. For example, the retrieval-augmented generation module 211 may increase an efficiency and/or accuracy of the inference process and/or the training process. Further, by adjusting the contextual data in this manner, the retrieval-augmented generation module 211 may enable the dynamic adjustment of the contextual data used by the machine learning model 140 during the same inference process and/or training process. For example, the retrieval-augmented generation module 211 may enable the dynamic adjustment of grammars (e.g., code language grammars) used by the machine learning model 140 during the same inference process and/or training process.

In some cases, the retrieval-augmented generation module 211 may periodically or aperiodically update the parameters 155. The retrieval-augmented generation module 211 may use a machine learning model (e.g., using reinforcement learning) to identify and/or update the parameters 155. For example, the retrieval-augmented generation module 211 may determine an output of the machine learning model 140 based on particular contextual data and/or particular parameters, provide the output, the particular contextual data, and/or the particular parameters to a second machine learning model (e.g., that uses a reward function to evaluate a quality and/or relevance of the particular contextual data and/or the particular parameters), and may update (e.g., and store) parameters based on an output of the second machine learning model (e.g., for subsequent use in determining contextual data). In some cases, the retrieval-augmented generation module 211 may adjust the parameters based on the training process (e.g., based on identifying a need for additional contextual data given an output, a token, etc. of the machine learning model).

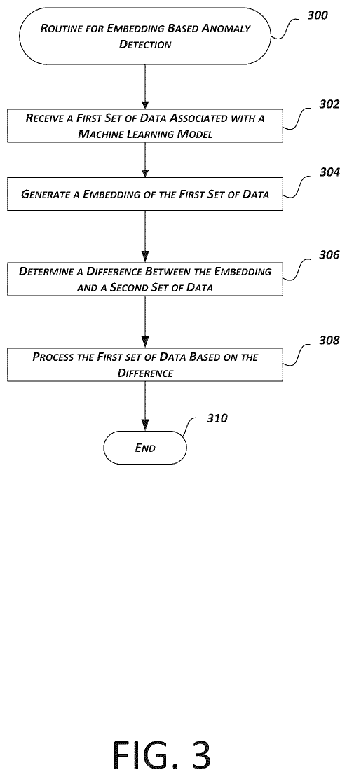

As discussed above, a computing system may generate an embedding based on an input to and/or an output from a machine learning model and may identify anomalous data based on the embedding. In some cases, the computing system may determine how to process the input and/or the output based on the identification of anomalous data. With reference to FIG. 3, an illustrative routine 300 will be described for embedding based anomaly detection using embeddings of a machine learning model. The routine 300 may be implemented for example, by the model management system 120 of FIG. 1 (e.g., which may include a computing device, data processing hardware, memory, etc.). In some cases, the routine 300 may be implemented by a processor. The routine 300 begins at block 302, where the computing system receives a first set of data associated with a machine learning model. In some cases, the machine learning model may be implemented by the computing system or a separate system. In some cases, the machine learning model may include a text-based machine learning model, an audio-based machine learning model, or an image-based machine learning model.

In some cases, the first set of data may be and/or may include an input for a machine learning model. For example, the computing system may obtain, from a user computing device, an input (e.g., a first input) that may include a request to implement a machine learning model. In some cases, the computing system may generate a prompt for the machine learning model based on the input.

In some cases, the first set of data may be and/or may include an output of a machine learning model. For example, the computing system may obtain, from the machine learning model, an output to route to a user computing device. In some cases, the machine learning model may generate the output in response to an input provided by the computing system.

In some cases, the computing system may determine that the first set of data is associated with the machine learning model. For example, the computing system may determine that the first set of data includes an input to and/or an output of the machine learning model.

Based on receiving the first set of data associated with the machine learning model (e.g., and determining that the first set of data is associated with the machine learning model), at block 304, the computing system generates an embedding (e.g., a first embedding) of the first set of data. In some cases, the computing system may generate the embedding using an embedding model of the computing system. For example, the computing system may identify a plurality of embeddings based on an input to the machine learning model and/or an output of the machine learning model. In some cases, the computing system may generate one or more embeddings for one or more tokens of the first set of data (e.g., embeddings for the tokens “what,” “is,” “a,” “good,” “time,” “to,” “eat,” “dinner,”) and may generate the embedding (e.g., a final embedding, a sentence embedding, a phrase embedding, etc.) for the first set of data based on the one or more embeddings and an attention mechanism applied to relationships between the one or more embeddings and/or corresponding dense layers.

In order to identify anomalous data, at block 306, the computing system determines a difference between the embedding and a second set of data (e.g., a set of anomalous data). For example, the second set of data may include one or more embeddings (e.g., vector embeddings) of anomalous data associated with the machine learning model. In some cases, the second set of data may include anomalous input data and/or anomalous output data. For example, the second set of data may include anomalous input data such as “cheat,” “kill,” etc. that are examples of anomalous data that may be input to the machine learning model and/or may include anomalous output data such as “cheat,” “kill,” etc. that are examples of anomalous data that may be output by the machine learning model.

The computing system may compare (e.g., using a vector search, a vector similarity search, etc.) the embedding and the second set of data (e.g., the one or more embeddings) to determine the difference between the embedding and the second set of data. For example, the computing system may compare a first embedding (e.g., corresponding to the input) to a third embedding of the second set of data and may compare a second embedding (e.g., corresponding to the output) to a fourth embedding of the second set of data. The computing system may compare the difference between the embedding and the second set of data to a threshold.

The computing system may obtain the second set of data from a data store. In some cases, the computing system may obtain the second set of data based on obtaining the first set of data (e.g., the input). In some cases, the second set of data may be based on (e.g., may include) two or more of text data, audio data, or image data.

In some cases, the computing system may determine a format of the second set of data. The computing system may adjust a format of the first set of data based on the format of the second set of data to obtain an adjusted first set of data. The computing system may generate the embedding using the adjusted first set of data. For example, the embedding may be an embedding of the adjusted first set of data.

Based on the difference between the embedding and the second set of data, the computing system may determine whether the first set of data and/or the embedding corresponds to (e.g., includes, represents, etc.) an anomaly. For example, if a difference between the embedding and the second set of data satisfies the threshold, the computing system may determine that the embedding corresponds to anomalous data. In another example, if a difference between the embedding and the second set of data does not satisfy a threshold, the computing system may determine that the embedding does not correspond to anomalous data.

In some cases, the computing system may update (e.g., dynamically) the second set of data (e.g., in real time). The computing system may dynamically update the second set of data in real time as user computing devices flag anomalous data, as the computing system determines an embedding corresponds to anomalous data, etc. (e.g., within seconds of the flagging of the anomalous data, the determining that the embedding corresponds to anomalous data, etc.). For example, the computing system may determine an embedding corresponds to, but does not match, the anomalous data and may add the embedding to the second set of data.

In some cases, the computing system may generate all or a portion of the second set of data. For example, the computing system may obtain a third set of data, normalize the third set of data to obtain a normalized third set of data, and generate a second embedding based on the normalized third set of data where the second set of data may include the second embedding.

In one example, the first set of data may include “ten steps to commit tax fraud.” The computing system may process (e.g., segment) the first set of data into one or more tokens (e.g., “ten,” “steps,” “to,” “commit,” “tax,” “fraud,” etc.) and generate one or more embeddings of the one or more tokens. The computing system may compare the one or more embeddings to the second set of data (e.g., embeddings of the second set of data). Based on a difference between the one or more embeddings and the second set of data (e.g., a difference between an embedding of the token “fraud” and an embedding of the token “crime” as included in the second set of data), the computing system may determine the first set of data (and the corresponding embedding) corresponds to anomalous data.

Using the determination of whether the embedding corresponds to anomalous data, at block 308, the computing system processes the first set of data based on the difference (e.g., based on comparing the embedding and the second set of data). The computing system may determine a manner of processing the first set of data (e.g., indicating whether the computing system is to drop, filter, route to a first destination, etc. the first set of data) and may process the first set of data according to the determined manner of processing. For example, based on determining that the first set of data corresponds to an anomaly, the computing system may drop the first set of data, route the first set of data to a computing device, generate a second prompt for the machine learning model, and/or generate an alert. In another example, based on determining that the first set of data does not correspond to an anomaly, the computing system may route the first set of data and/or a prompt based on the first set of data to the machine learning model and/or a system implementing the machine learning model. In some cases, based on the manner of processing, the computing system may drop an input and the machine learning model may generate an output based on a second input. In another example, the computing system may route the input to a system implementing the machine learning model and the machine learning model may generate an output based on the input.

In some cases, the computing system may receive a request to moderate one or more of an input to the machine learning model or an output of the machine learning model. The computing system may determine the manner of processing and may process the first set of data based on the request.

In some cases, the computing system may process an input to the machine learning model and an output of the machine learning model (e.g., that the machine learning model generates based on the input). For example, the computing system may generate a first embedding (e.g., a first vector embedding) of the input, determine a manner of processing the input, process the input, generate a second embedding (e.g., a second vector embedding) of the output, determine a manner of processing the output, and process the output. The routine 300 then ends at block 310.

In various embodiments, the routine 300 may include more, fewer, different, or different combinations of blocks than those depicted in FIG. 3. For example, the routine 300 may, in some embodiments, may not include processing the first set of data. As a further example, block 304 may be omitted, in some cases, such that the computing system may noy generate the embedding. The routine 300 depicted in FIG. 3 is thus understood to be illustrative and not limiting.

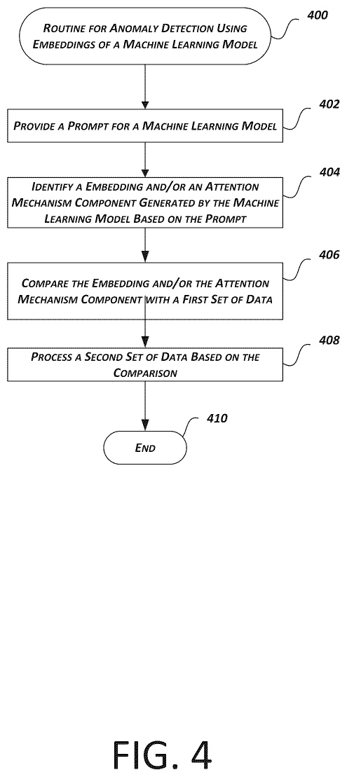

As discussed above, a computing system may obtain an embedding generated by an embedding model of a machine learning model and may identify anomalous data based on the embedding. In some cases, the computing system may determine how to process an input to and/or an output of the machine learning model based on the identification of anomalous data. With reference to FIG. 4, an illustrative routine 400 will be described for anomaly detection using embeddings of a machine learning model. The routine 400 may be implemented for example, by the model management system 120 of FIG. 1 (e.g., which may include a computing device, data processing hardware, memory, etc.). In some cases, the routine 400 may be implemented by a processor. The routine 400 begins at block 402, where the computing system provides a prompt for a machine learning model (e.g., to a separate computing system, to the machine learning model, etc.). In some cases, the machine learning model may include a text-based machine learning model, an audio-based machine learning model, or an image-based machine learning model. In some cases, the prompt may be based on one or more of text data, audio data, or image data.

The computing system may generate the prompt. For example, the computing system may generate the prompt based on an input (e.g., including and/or indicating a request to implement a machine learning model) obtained by the computing system (e.g., from a user computing device).

In response to providing the prompt, the computing system and/or a separate computing system may implement the machine learning model (e.g., apply the machine learning model to the prompt). For example, the computing system and/or a separate computing system may implement the machine learning model by identifying a weight associated with the machine learning model, modifying the at least a portion of the prompt using the weight, and generating an output.

Based on providing the prompt for the machine learning model, at block 404, the computing system identifies an embedding (e.g., a first embedding, a first vector embedding, etc.) and/or an attention mechanism component (e.g., a query, key, value vector) generated by the machine learning model based on the prompt. For example, the machine learning model may generate a stream of embeddings (e.g., a plurality of vector embeddings) and/or attention mechanism components based on implementation of the machine learning model according to the prompt. The computing system may identify a particular embedding and/or attention mechanism component from the stream generated by the machine learning model based on the prompt. In some cases, the machine learning model may generate the embeddings as the machine learning model performs an inference process and/or a training process. In some cases, the machine learning model may generate one or more embeddings for one or more tokens of the prompt (e.g., embeddings for the tokens “what,” “is,” “a,” “good,” “time,” “to,” “eat,” “dinner,”) and may generate the embedding (e.g., a final embedding, a sentence embedding, a phrase embedding, etc.) for the prompt based on the one or more embeddings and an attention mechanism applied to relationships between the one or more embeddings and/or corresponding dense layers. In some cases, the computing system select a particular embedding and/or attention mechanism component from the stream. For example, the computing system may identify the embedding based on a particular token (e.g., a final token as modified based on a weight) generated by the machine learning model for a given prompt. In some cases, the computing system may identify the embedding and/or the attention mechanism component in real time.

In some cases, the computing system may identify multiple embeddings and/or multiple attention mechanism components generated by the machine learning model (e.g., generated by different embedding models of the same machine learning model for the same token) based on the prompt. For example, the computing system may identify a second embedding generated by the machine learning model.

In order to identify anomalous data, at block 406, the computing system compares the embedding (e.g., the multiple embeddings) and/or the attention mechanism component with a first set of data (e.g., a set of anomalous data associated with the machine learning model and/or a set of anon-anomalous data associated with the machine learning model). For example, the first set of data may include one or more embeddings (e.g., vector embeddings) of anomalous data associated with the machine learning model. In some cases, the first set of data may include anomalous data for output by a machine learning model. For example, the first set of data may include data flagged as being anomalous for a machine learning model such as embeddings correspond to the tokens “cheat,” “kill,” etc.

The computing system may obtain the first set of data from a data store (e.g., a local data store, a remote data store, etc.). For example, the computing system may obtain the first set of data using a query. In some cases, the first set of data may be machine learning model specific. For example, it may be considered anomalous for a general chatbot machine learning model to generate financial advice, but it may not be considered anomalous for a financial advice oriented machine learning model to generate financial advice. In some cases, all or a portion a plurality of machine learning models may be associated with a respective set of data (e.g., a respective set of anomalous data) of a plurality of sets of data stored by the data store.

In some cases, the computing system may obtain an identifier of the machine learning model and may identify the first set of data based on the identifier. For example, the computing system may identify a task, training data, and/or an implementation of the machine learning model using the identifier and may identify a first set of data associated with the task, the training data, and/or the implementation.

The computing system may compare (e.g., using a vector search, a vector similarity search, etc.) the embedding and/or the attention mechanism component with the first set of data (e.g., the one or more embeddings) to determine the difference between the embedding and/or the attention mechanism component and the first set of data. Based on comparing the embedding and/or the attention mechanism component with the first set of data, the computing system may determine whether the embedding and/or the attention mechanism component corresponds to anomalous data by comparing the difference between the embedding and/or the attention mechanism component and the first set of data to a threshold. For example, if a difference between the embedding and the first set of data satisfies the threshold, the computing system may determine that the embedding corresponds to anomalous data. In another example, if a difference between the embedding and the first set of data does not satisfy a threshold, the computing system may determine that the embedding does not correspond to anomalous data.

In one example, the embedding corresponds to the token “fraud.” The computing system may compare the embedding to the first set of data (e.g., embeddings of the first set of data). Based on a difference between the one or more embeddings and the first set of data (e.g., a difference between an embedding of the token “fraud” and an embedding of the token “crime” as included in the first set of data), the computing system may determine the embedding corresponds to anomalous data.

Using the determination of whether the embedding and/or the attention mechanism component corresponds to anomalous data, at block 408, the computing system processes a second set of data (e.g., an input to and/or an output of the machine learning model) based on the comparison (e.g., based on comparing the difference between the embedding and the first set of data to the threshold). The computing system may determine a manner of processing the second set of data (e.g., indicating whether the computing system is to drop, filter, route to a first data destination, etc. the second set of data) and may process the second set of data according to the determined manner of processing. For example, the computing system may route the second set of data to a user computing device (e.g., corresponding to a provided input) or route the second set of data to a system implementing the machine learning model (e.g., based on determining that the embedding does not correspond to anomalous data).

In some cases, the computing system may instruct termination of implementation of the machine learning model based on the manner of processing. For example, the computing system may terminate implementation of the machine learning model (e.g., based on determining that the embedding does correspond to anomalous data).

In some cases, the computing system may generate an alert (e.g., indicating the anomalous data) based on the manner of processing. For example, the computing system may generate the alert and cause display of the alert via a user computing device (e.g., based on determining that the embedding does correspond to anomalous data).

In some cases, the computing system may obtain (e.g., from a user computing device) an input for the machine learning model. Based on the manner of processing the second set of set of data, the computing system may process (e.g., filter) the input. Further, the computing system may provide the processed input (e.g., may provide the filtered input to the machine learning model or a system implementing the machine learning model).

In some cases, the computing system may obtain (e.g., from the machine learning model, from a system implementing the machine learning model, etc.) an output of the machine learning model. In some cases, the machine learning model may generate the output based on the prompt and the plurality of embeddings (e.g., where the plurality of embeddings may be separate and distinct from the output). Based on the manner of processing the second set of set of data, the computing system may process (e.g., filter) the output. Further, the computing system may provide the processed output (e.g., may provide the filtered output to a user computing device).

In some cases, the computing system may generate the embedding using a first version of an embedding model and the machine learning model may include and/or may implement a second version of the embedding model. For example, the computing system may provide the second set of data to a second computing system implementing a second machine learning model (e.g., including and/or implementing) a second version of the embedding model based on the manner of processing. In some cases, the computing system may generate the embedding using an embedding model of the machine learning model.

In some cases, the computing system may determine a task associated with the machine learning model (e.g., based on the input). The computing system may determine a relevance of the embedding to the task based on comparing the embedding with the first set of data. In some cases, the computing system may determine the manner of processing based on the relevance of the embedding to the task.

In some cases, the computing system may generate all or a portion of the first set of data. For example, the computing system may output a prompt for the machine learning model. The prompt may include one or more of a prompt to generate anomalous outputs or a prompt to generate non-anomalous outputs. The computing system may obtain an output from the computing system based on the prompt and may store the output in the data store (e.g., as anomalous data or as non-anomalous data depending on the prompt) such that the first set of data may be based on the output. The routine 400 then ends at block 410.

In various embodiments, the routine 400 may include more, fewer, different, or different combinations of blocks than those depicted in FIG. 4. For example, the routine 400 may, in some embodiments, may not include providing the prompt to the computing system. As a further example, block 406 may be omitted, in some cases, such that the computing system may not compare the embedding with the first set of data. The routine 400 depicted in FIG. 4 is thus understood to be illustrative and not limiting.

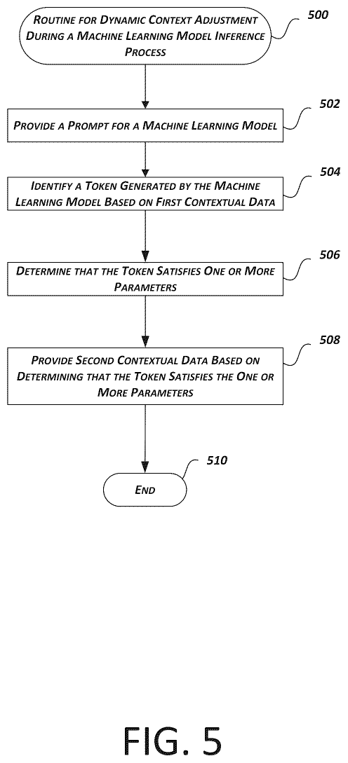

As discussed above, a computing system may obtain tokens generated by a machine learning model during an inference process and/or a training process and may identify additional contextual data based on the tokens. In some cases, the computing system may dynamically provide the additional contextual data to the machine learning model for generation of an output. With reference to FIG. 5, an illustrative routine 500 will be described for dynamic context adjustment during a machine learning model inference process and/or a machine learning model training process. The routine 500 may be implemented for example, by the model management system 120 of FIG. 1 (e.g., which may include a computing device, data processing hardware, memory, etc.). In some cases, the routine 500 may be implemented by a processor. The routine 500 begins at block 502, where the computing system provides a prompt for a machine learning model (e.g., to a separate computing system, to the machine learning model, etc.). For example, the prompt may include one or more of a request to generate code, a request to answer a question, or a request to perform logical reasoning. In some cases, the machine learning model may include a text-based machine learning model, an audio-based machine learning model, or an image-based machine learning model. In some cases, the prompt may be based on one or more of text data, audio data, or image data.

In some cases, the computing system may generate the prompt. For example, the computing system may generate the prompt based on an input (e.g., including and/or indicating a request to implement a machine learning model) obtained by the computing system (e.g., from a user computing device).

In response to providing the prompt, the computing system and/or a separate computing system may implement the machine learning model according to the prompt and first contextual data. For example, the computing system may perform retrieval-augmented generation based on the prompt to obtain first contextual data associated with the prompt and may provide the first contextual data with the prompt (e.g., as part of the prompt). To perform the retrieval-augmented generation, the computing system may determine that at least a portion of the input satisfies one or more second parameters, obtain, from a data store, a second set of data associated with the at least a portion of the input based on determining that the at least a portion of the input satisfies the one or more second parameters, and may generate the prompt based on the input and the second set of data.

In response to providing the prompt, at block 504, the computing system identifies a token (e.g., a first token, a first data unit, etc.) generated by the machine learning model based on first contextual data. For example, the computing system may obtain the token from a stream of tokens (e.g., a data stream) in real time as the machine learning model generates the stream of tokens. The machine learning model may generate the stream of tokens as part of an inference process and/or a training process of the machine learning model based on implementation of the machine learning model according to the prompt and the first contextual data. In some cases, the machine learning model may generate the stream of tokens (e.g., the token) based on the first contextual data.

In some cases, the computing system may identify one or more probabilities (e.g., generated by the machine learning model) associated with the token. For example, the machine learning model may identify one or more probabilities that a given token is to be the next output token in a sequence of tokens. The computing system may identify the token based on the one or more probabilities.

In order to identify a need for additional contextual data, at block 506, the computing system determines that the token satisfies one or more parameters (e.g., one or more first parameters associated with adjustment of the first contextual data). The one or more parameters may be based on one or more of a difference in contextual data, a time period, a number of data units, or data included within a particular token. In some cases, to determine that the token satisfies one or more parameters, the computing system may determine that the token satisfies at least two of the difference in contextual data, the time period, the number of tokens, or the data included within the particular token.

In some cases, the one or more parameters may indicate one or more of a term, a modification to semantics, a modification to complexity, or a background condition. To determine that the token satisfies the one or mor parameters, the computing system may determine that data included within the token indicates the term, the modification to the semantics, the modification to the complexity, or the background condition indicated by the one or more parameters.

In some cases, the one or more parameters may indicate a time period. To determine that the token satisfies the one or more parameters, the computing system may determine that a time period associated with the inference process and/or the training process satisfies the time period indicated by the one or more parameters.

In some cases, the one or more parameters may indicate a number of tokens. To determine that the token satisfies the one or more parameters, the computing system may determine that a number of tokens generated by the machine learning model satisfies the number of tokens indicated by the one or more parameters.

In some cases, the one or more parameters may indicate a difference in contextual data. To determine that the token satisfies the one or more parameters, the computing system may determine that a difference between the first contextual data and third contextual data satisfies the difference in contextual indicated by the one or more parameters.

In some cases, the computing system may identify a second token generated by the machine learning model. To determine that the token satisfies the one or more parameters, the computing system may determine that one or more of the token or the second token satisfies the one or more parameters.

In response to determining that the token satisfies the one or more parameters, at block 508, the computing system provides (e.g., to the machine learning model, to a system implementing the machine learning model, etc.) second contextual data (e.g., non-textual data) based on determining that the token satisfies the one or more parameters. The second contextual data may be associated with the token, the second token, etc. The computing system may obtain the second contextual data from a data store external to the system. To obtain the second contextual data, the computing system may generate a query based on determining that the token satisfies the one or more parameters and may obtain the second contextual data based on execution of the query. In some cases, to obtain the second contextual data, the computing system may perform a similarity search (e.g., the computing system may determine a difference between an embedding of the token and an embedding of the second contextual data). The computing system may identify the second contextual data based on determining the difference between the embedding of the token and the embedding of the second contextual data satisfies a threshold.

In some cases, to provide the second contextual data, the computing system may integrate the second contextual data with an input and/or the first contextual data for the machine learning model. In one example, to integrate the second contextual data, the computing system may filter the first contextual data based on the second contextual data to obtain the at least a portion of the first contextual data. In another example, to integrate the second contextual data, the computing system may score the second contextual data and the at least a portion of the first contextual data to obtain scored contextual data. In another example, to integrate the second contextual data, the computing system may weight (e.g., may adjust a weight of) an input, the first contextual data and/or the second contextual data. In another example, to integrate the second contextual data, the computing system may identify an input for the machine learning model, identify a position (e.g., a semantic boundary) for the second contextual data within the input, generate an adjusted input based on insertion of the second contextual data into the input at the position, and provide the second contextual data by providing the adjusted input.

Based on providing the second contextual data to the machine learning model, the computing system may obtain (e.g., from the machine learning model, from a system implementing the machine learning model, etc.) an output of the machine learning model based on the second contextual data and at least a portion of the first contextual data. For example, the machine learning model may generate an output based on scored contextual data. In some cases, the machine learning model may generate the output based on the prompt and stream of tokens (e.g., where the stream of tokens may be separate and distinct from the output). The computing system may provide (e.g., to a user computing device) the output based on obtaining the input from the user computing device.

In some cases, the machine learning model may generate a second stream of tokens (e.g., a second token) based on the second contextual data and at least a portion of the first contextual data.

In some cases, the computing system may determine a likelihood of a second token (e.g., a second data unit) of the stream of tokens satisfying the one or more parameters in response to determining that the token satisfies the one or more parameters. For example, the computing system may determine a likelihood of a future token satisfying the one or more parameters. The computing system may determine that the likelihood satisfies a threshold. The computing system may provide the second contextual data based on determining that the likelihood satisfies the threshold.

In one example, the token is “TypeScript.” The computing system may determine a need for additional contextual data based on the token including the term “TypeScript,” based on the machine learning model having generated over 100 tokens without the computing system providing additional contextual data, based on determining the contextual data previously provided to the machine learning model corresponds to less than 5% of the available contextual data, and/or based on the tokens generated by the machine learning model indicating a shift from “JavaScript” to “TypeScript.” Based on identifying the need for additional contextual data, the computing system may generate a query based on the token, may search a contextual data store using the query, may identify the additional contextual data, and may provide the additional contextual data to the machine learning model. The routine 500 then ends at block 510.

In various embodiments, the routine 500 may include more, fewer, different, or different combinations of blocks than those depicted in FIG. 5. For example, the routine 500 may, in some embodiments, may not include providing the prompt to the computing system. As a further example, block 506 may be omitted, in some cases, such that the computing system may not determine that the token satisfies the one or more parameters. The routine 500 depicted in FIG. 5 is thus understood to be illustrative and not limiting.

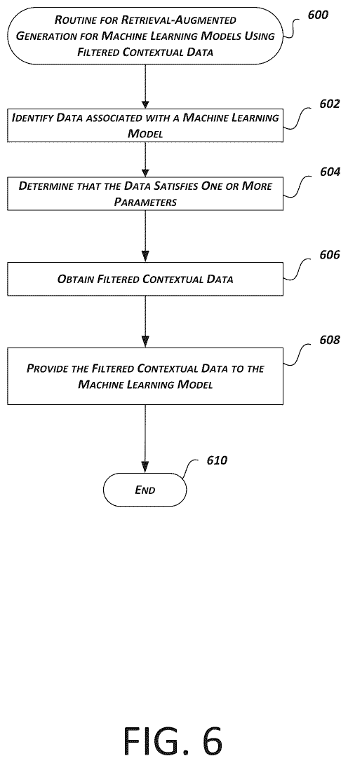

As discussed above, a computing system may obtain data associated with a machine learning model (e.g., tokens generated by a machine learning model during an inference process and/or a training process, an input to the machine learning model, an output of the machine learning model, etc.) and may identify filtered contextual data to provide to the model based on the data. In some cases, the computing system may dynamically filter the contextual data based on comparing tags associated with the data with tags associated with the contextual data. With reference to FIG. 6, an illustrative routine 600 will be described for identifying filtered contextual data for retrieval-augmented generation for a machine learning model. The routine 600 may be implemented for example, by the model management system 120 of FIG. 1 (e.g., which may include a computing device, data processing hardware, memory, etc.). In some cases, the routine 600 may be implemented by a processor. The routine 600 begins at block 602, where the computing system identifies data associated with a machine learning model. In some cases, the data may include and/or may be based on one or more of text data, audio data, or image data. In some cases, the machine learning model may include a text-based machine learning model, an audio-based machine learning model, or an image-based machine learning model.

The data may include one or more tokens generated by a machine learning model during an inference process and/or a training process, an input to the machine learning model, an output of the machine learning model, a prompt to the machine learning model, etc. In some cases, the computing system may provide a prompt for the machine learning model (e.g., to a separate computing system, to the machine learning model, etc.). For example, the prompt may include one or more of a request to generate code, a request to answer a question, or a request to perform logical reasoning. In some cases, in response to providing the prompt, the computing system and/or a separate computing system may implement the machine learning model according to the prompt and first contextual data. For example, the computing system may perform retrieval-augmented generation based on the prompt to obtain first contextual data associated with the prompt and may provide the first contextual data with the prompt (e.g., as part of the prompt). To perform the retrieval-augmented generation, the computing system may determine that at least a portion of an input satisfies one or more parameters, obtain, from a data store, contextual data associated with the at least a portion of the input based on determining that the at least a portion of the input satisfies the one or more parameters, and may generate the prompt based on the input and the second set of data. In response to providing the prompt, the computing system may obtain the data (e.g., from the machine learning model) such that the data may be based on contextual data.

The data may be associated with one or more first identifiers (e.g., tags, keywords, labels, flags, markers, etc.). For example, the data may include and/or may be based on an input provided by a user computing device and the one or more first identifiers may be associated with the user computing device, an organization associated with the user computing device, a user associated with the user computing device, a clearance level, etc. In some cases, the computing system may identify the one or more first identifiers based on the data. For example, the computing system may identify a user computing device providing an input associated with the data and may obtain, from a data store, the one or more first identifiers (e.g., as stored in the data store) that are associated with the user computing device, an organization associated with the user computing device, a user associated with the user computing device, the clearance level, etc.

In response to identifying the data associated with the machine learning model, at block 604, the computing system determines that the data satisfies one or more parameters (e.g., parameters associated with provision of contextual data). Based on determining that the data satisfies the one or more parameters, the computing system may identify a need for contextual data (e.g., to provide additional context relative to the data).

The one or more parameters may be based on one or more of a term, a modification to semantics, a modification to complexity, a background condition, a difference in contextual data, a time period, a number of tokens, or data included within a particular token. To determine that the token satisfies the one or mor parameters, the computing system may determine that data is associated with (e.g., includes, indicates, etc.) the term, the modification to semantics, the modification to complexity, the background condition, the difference in contextual data, the time period, the number of tokens, or the data included within the particular token indicated by the one or more parameters. In some cases, to determine that the data satisfies one or more parameters, the computing system may determine that the data satisfies at least two of the term, the modification to semantics, the modification to complexity, the background condition, the difference in contextual data, the time period, the number of tokens, or the data included within the particular token.

In some cases, the computing system may adjust (e.g., dynamically adjust) the one or more parameters. For example, the computing system may update the one or more parameters using a machine learning model (e.g., using reinforcement learning) based on an output of the machine learning model.

In order to preserve privacy associated with contextual data and to maintain authorizations (e.g., data authorizations) and/or restrictions (e.g., data restrictions) associated with a user, a user computing device, an organization, a clearance level, etc., at block 606, the computing system obtains filtered contextual data (e.g., based on determining that the data satisfies one or more parameters). The filtered contextual data may include textual data and/or non-textual data. In some cases, the computing system may obtain contextual data and filter the obtained contextual data (e.g., to remove at least a portion of the obtained contextual data and obtain filtered contextual data). For example, the computing system may obtain contextual data from an external and/or remote data store relative to the computing system and may filter the obtained contextual data. In some cases, the computing system may obtain the filtered contextual data without separately filtering the contextual data. For example, the computing system may identify a portion of the contextual data (e.g., corresponding to the filtered contextual data) and may obtain the portion of the contextual data from an external and/or remote data store.

The contextual data may be associated with one or more second identifiers (e.g., tags, keywords, labels, flags, markers, etc.). For example, the contextual data may be associated with one or more second identifiers indicating a subject of the contextual data, a source of the contextual data, a user computing device associated with the contextual data, a user associated with the contextual data, an organization associated with the contextual data, or a clearance level associated with the contextual data (e.g., a user computing device, an organization, a user, etc. authorized to access and/or use or restricted from accessing and/or using all or a portion of the contextual data). In some cases, the computing system may obtain the one or more second identifiers (e.g., from a data store). In some cases, the computing system may obtain criterion indicating contextual data that a user computing device, an organization, a user, etc. is authorized to access and/or use or is restricted from accessing and/or using. In some cases, at least a portion of the one or more first identifiers may be different from at least a portion of the one or more second identifiers.

In some cases, the computing system may generate the one or more second identifiers. For example, the computing system may tag the contextual data to generate the one or more second identifiers.

To filter the contextual data and/or obtain the filtered contextual data, the computing system may compare the one or more first identifiers with the one or more second identifiers. In some cases, to obtain the filtered contextual data, the computing system may identify the filtered contextual data based on the one or more first identifiers and the criterion indicating contextual data that a user associated with the one or more first identifiers is authorized to access. Based on comparing the one or more first identifiers with the one or more second identifiers, the computing system may identify at least a portion of the contextual data for filtering (e.g., removal). For example, the computing system may identify (e.g., to provide to the machine learning model) a first portion of the contextual data that is associated with a first portion of the one or more second tags that correspond to (e.g., match) a tag of the one or more first tags and may identify (e.g., to not provide to the machine learning model) a second portion of the contextual data that is associated with a second portion of the one or more second tags that do not correspond to (e.g., do not match) a tag of the one or more first tags. In another example, the computing system may identify the contextual data is associated with one or more second tags that do not correspond to (e.g., do not match) a tag of the one or more first tags and may not provide contextual data to the machine learning model.

In response to obtaining the filtered contextual data, at block 608, the computing system provides (e.g., to the machine learning model, to a system implementing the machine learning model, etc.) the filtered contextual data. Based on providing the filtered contextual data to the machine learning model, the computing system may obtain (e.g., from the machine learning model, from a system implementing the machine learning model, etc.) an output of the machine learning model based on the filtered contextual data. For example, the machine learning model may generate an output based on the filtered contextual data. The computing system may provide (e.g., to a user computing device) the output based on obtaining an input from the user computing device. The routine 600 then ends at block 610.

In various embodiments, the routine 600 may include more, fewer, different, or different combinations of blocks than those depicted in FIG. 6. For example, the routine 600 may, in some embodiments, may not include providing the filtered contextual data to the machine learning model. As a further example, block 602 may be omitted, in some cases, such that the computing system may not identify the data. The routine 600 depicted in FIG. 6 is thus understood to be illustrative and not limiting.

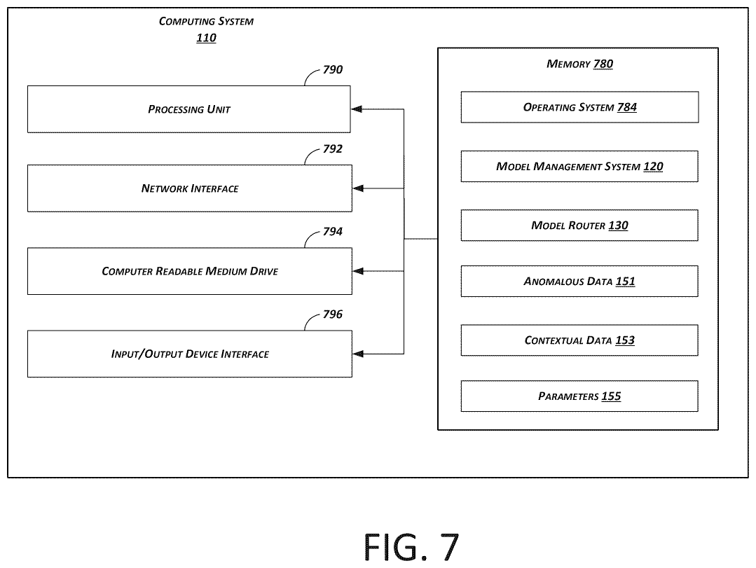

FIG. 7 depicts a general architecture of computing system 110 that operates to manage (e.g., route, process, etc.) data associated with a machine learning model. The general architecture of the computing system 110 depicted in FIG. 7 includes an arrangement of computer hardware and software modules that may be used to implement aspects of the present disclosure. For example, aspects of the present disclosure may be implemented by computer hardware modules (e.g., a processor, a processing device, a computing device, etc.) or may be implemented via software modules. In some cases, one or more first aspects of the present disclosure may be implemented by computer hardware modules and one or more second aspects of the present disclosure may be implemented via software modules. The hardware modules may be implemented with physical electronic devices. The computing system 110 may include many more (or fewer) elements than those shown in FIG. 7. It is not necessary, however, that all of these generally conventional elements be shown in order to provide an enabling disclosure. Additionally, the general architecture illustrated in FIG. 7 may be used to implement one or more of the other components illustrated in FIG. 1.

As illustrated, the computing system 110 includes a processing unit 790, a network interface 792, a computer readable medium drive 794, and an input/output device interface 796, all of which may communicate with one another by way of a communication bus. The network interface 792 may provide connectivity to one or more networks or computing systems. The processing unit 790 may thus receive information and instructions from other computing systems or services via the network 104. The processing unit 790 may also communicate to and from memory 780 and further provide output information for an optional display (not shown) via the input/output device interface 796. The input/output device interface 796 may also accept input from an optional input device (not shown).

The memory 780 may contain computer program instructions (grouped as units in some embodiments) that the processing unit 790 executes in order to implement one or more aspects of the present disclosure, along with data used to facilitate or support such execution. While shown in FIG. 7 as a single set of memory 780, memory 780 may in practice be divided into tiers, such as primary memory and secondary memory, which tiers may include (but are not limited to) RAM, 3D XPOINT memory, flash memory, magnetic storage, and the like. For example, primary memory may be assumed for the purposes of description to represent a main working memory of the computing system 110, with a higher speed but lower total capacity than a secondary memory, tertiary memory, etc.

The memory 780 may store an operating system 784 that provides computer program instructions for use by the processing unit 790 in the general administration and operation of the computing system 110. The memory 780 may further include computer program instructions and other information for implementing aspects of the present disclosure. For example, in one embodiment, the memory 780 includes a model management system 120 to manage the machine learning model as described above and/or a model router 130 to route data to the machine learning model. The memory 780 also includes anomalous data 151, contextual data 153, and parameters 155. The anomalous data 151, the contextual data 153, and/or the parameters 155 may be cached locally to the computing system 110, such as in the form of a memory mapped file. For example, the computing system 110 may obtain the anomalous data 151, the contextual data 153, and/or the parameters 155 and store the anomalous data 151, the contextual data 153, and/or the parameters 155 in memory 280.

The computing system 110 of FIG. 7 is one illustrative configuration of such a device, of which others are possible. For example, while shown as a single device, the computing system 110 may in some embodiments be implemented as a logical device hosted by multiple physical host devices. In other embodiments, the computing system 110 may be implemented as one or more virtual devices executing on a physical computing device. While described in FIG. 7 as the computing system 110, similar components may be utilized in some embodiments to implement other devices shown in the environment 100 of FIG. 1.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

Various example embodiments of the disclosure can be described by the following clauses:

Clause 1: A computing system comprising:
data processing hardware; and
memory in communication with the data processing hardware, the memory storing instructions, wherein execution of the instructions by the data processing hardware causes the data processing hardware to:
   obtain, from a user computing device, a first input, wherein the first input comprises a request to generate an output using a machine learning model;
   obtain, from a data store, a set of data based on obtaining the first input, wherein the set of data comprises one or more vector embeddings of anomalous data associated with the machine learning model;
   generate, using an embedding model, a first vector embedding of the first input;
   compare, using a vector search, the first vector embedding and the one or more vector embeddings;
   determine a manner of processing the first input based on comparing the first vector embedding and the one or more vector embeddings, wherein the manner of processing the first input indicates to drop the first input, route the first input to a first destination, or filter the first input;
   route the first input to the machine learning model based on the manner of processing the first input;
   obtain a first output of the machine learning model based on routing the first input to the machine learning model;
   generate, using the embedding model, a second vector embedding of the first output;
   compare, using the vector search, the second vector embedding and the one or more vector embeddings;
   determine a manner of processing the first output based on comparing the first vector embedding and the one or more vector embeddings, wherein the manner of processing the first output indicates to drop the first output, route the first output to a second destination, or filter the first output; and
   process the first output according to the manner of processing the first output.

Clause 2: The computing system of Clause 1, wherein the execution of the instructions by the data processing hardware further causes the data processing hardware to:
obtain a second input;
generate, using the embedding model, a second vector embedding of the second input;
compare the second vector embedding and the one or more vector embeddings;
determine a manner of processing the second input based on comparing the second vector embedding and the one or more vector embeddings; and
drop the second input based on the manner of processing the second input.

Clause 3: The computing system of Clause 1, wherein to route the first input, the execution of the instructions by the data processing hardware further causes the data processing hardware to:
route the first input to a second computing system, wherein the second computing system implements the machine learning model, and wherein the machine learning model generates the first output based on the first input.

Clause 4: The computing system of Clause 1, wherein to compare the first vector embedding and one or more vector embeddings, the execution of the instructions by the data processing hardware further causes the data processing hardware to:
compare the first vector embedding and a third vector embedding of the one or more vector embeddings, and

wherein to compare the second vector embedding and the one or more vector embeddings, the execution of the instructions by the data processing hardware further causes the data processing hardware to:
compare the second vector embedding and a fourth vector embedding of the one or more vector embeddings.

Clause 5: A method comprising:
receiving, from a computing system, a first set of data associated with a machine learning model;
generating, using an embedding model, a first embedding of the first set of data based on the first set of data being associated with the machine learning model;
determining a difference between the first embedding and a second set of data stored in a data store;
determining a manner of processing the first set of data based on the difference between the first embedding and the second set of data; and
processing the first set of data according to the manner of processing the first set of data.

Clause 6: The method of Clause 5, further comprising:
determining a format of the second set of data; and
adjusting a format of the first set of data based on the format of the second set of data to obtain an adjusted first set of data, wherein the first embedding comprises an embedding of the adjusted first set of data.

Clause 7: The method of Clause 5, further comprising:
receiving, from the computing system, an input, wherein the input comprises a request to generate an output using the machine learning model, and wherein the first set of data is based on the input.

Clause 8: The method of Clause 5, wherein the computing system implements the machine learning model, and wherein the first set of data comprises an output of the machine learning model.

Clause 9: The method of Clause 5, wherein determining the difference between the first embedding and the second set of data comprises:
performing a vector similarity search.

Clause 10: The method of Clause 5, further comprising:
comparing the difference between the first embedding and the second set of data to a threshold, wherein determining the manner of processing the first set of data is further based on comparing the difference between the first embedding and the second set of data to the threshold.

Clause 11: The method of Clause 5, further comprising:
determining the first set of data represents an anomaly based on the difference between the first embedding and the second set of data,

wherein processing the first set of data comprises one or more of:
dropping the first set of data based on determining the first set of data represents the anomaly;
routing the first set of data to a computing device based on determining the first set of data represents the anomaly; or
generating an alert based on determining the first set of data represents the anomaly.

Clause 12: The method of Clause 5, wherein processing the first set of data comprises one or more of:
routing the first set of data to the computing system;
routing a prompt based on the first set of data to the computing system; or
routing the first set of data to a computing device.

Clause 13: The method of Clause 5, further comprising:
receiving, from the computing system, an input;
generating a first prompt for the machine learning model based on the input, wherein the first set of data comprises an output of the machine learning model;
determining the first set of data represents an anomaly based on the difference between the first embedding and the second set of data; and
generating a second prompt for the machine learning model based on determining the first set of data represents the anomaly.

Clause 14: The method of Clause 5, further comprising:
obtaining a third set of data;
normalizing the third set of data to obtain a normalized third set of data; and
generating a second embedding based on the normalized third set of data, wherein the second set of data comprises the second embedding.

Clause 15: The method of Clause 5, further comprising:
updating, in real time, the second set of data.

Clause 16: One or more non-transitory computer-readable media including computer-executable instructions, wherein execution of the computer-executable instructions by a first computing system including a processor causes the first computing system to:
receive, from a second computing system, a first set of data associated with a machine learning model;
compare a second set of data and a first embedding of the first set of data based on the first set of data being associated with the machine learning model;
determine a manner of processing the first set of data based on comparing the second set of data and the first embedding; and
process the first set of data according to the manner of processing the first set of data.

Clause 17: The one or more non-transitory computer-readable media of Clause 16, wherein the execution of the computer-executable instructions by the first computing system further causes the first computing system to:
obtain, from a data store, the second set of data, wherein the second set of data comprises anomalous data.

Clause 18: The one or more non-transitory computer-readable media of Clause 16, wherein the machine learning model comprises a text-based machine learning model, an audio-based machine learning model, or an image-based machine learning model, and wherein the second set of data is based on two or more of text data, audio data, or image data.

Clause 19: The one or more non-transitory computer-readable media of Clause 16, wherein the first set of data comprises one or more of an input to the machine learning model or an output of the machine learning model.

Clause 20: The one or more non-transitory computer-readable media of Clause 16, wherein the execution of the computer-executable instructions by the first computing system further causes the first computing system to:
receive a request to moderate one or more of an input to the machine learning model or an output of the machine learning model, wherein the manner of processing the first set of data is based on the request.

Various example embodiments of the disclosure can be described by the following clauses:

Clause 1: A computing system comprising:
data processing hardware; and
memory in communication with the data processing hardware, the memory storing instructions, wherein execution of the instructions by the data processing hardware causes the data processing hardware to:
   obtain, from a user computing device, an input, wherein the input comprises a request to generate an output using a machine learning model, wherein the computing system generates a prompt for the machine learning model based on the input, and wherein the prompt comprises at least a portion of the input and at least a portion of additional data;
   provide, to a second computing system, the prompt, wherein the second computing system implements the machine learning model;
   identify, in real time, a vector embedding of a first plurality of vector embeddings generated by the machine learning model based on the prompt;
   obtain, from a data store, a first set of data associated with the machine learning model, wherein each machine learning model of a plurality of machine learning models is associated with a respective set of data of a plurality of sets of data stored by the data store, wherein the first set of data comprises a second plurality of vector embeddings;
   compare the vector embedding generated by the machine learning model with the second plurality of vector embeddings;
   determine a manner of processing a second set of data associated with the machine learning model based on comparing the vector embedding generated by the machine learning model with the second plurality of vector embeddings and based on one or more of a query vector, a key vector, or a value vector associated with an attention mechanism of the machine learning model, wherein the second set of data comprises a respective input to the machine learning model or a respective output of the machine learning model; and
   process the second set of data according to the manner of processing the second set of data.

Clause 2: The computing system of Clause 1, wherein the execution of the instructions by the data processing hardware further causes the data processing hardware to:
obtain an identifier of the machine learning model, and
identify the first set of data based on the identifier of the machine learning model, wherein the first set of data is based on one or more of a task, training data, or an implementation associated with the machine learning model.

Clause 3: The computing system of Clause 1, wherein to process the second set of data, the execution of the instructions by the data processing hardware further causes the data processing hardware to one or more of:
filter the second set of data;
drop the second set of data;
route the second set of data to the second computing system; or
route the second set of data to the user computing device.

Clause 4: The computing system of Clause 1, wherein the machine learning model generates an output based on the prompt and the first plurality of vector embeddings, and wherein the first plurality of vector embeddings are separate and distinct from the output.

Clause 5: A method comprising:
providing, to a computing system, a first prompt for a first machine learning model, wherein the computing system implements the first machine learning model;
identifying a first embedding generated by the first machine learning model based on the first prompt;
obtaining, from a data store, a first set of data, wherein the first set of data is associated with the first machine learning model;
comparing the first embedding generated by the first machine learning model with the first set of data;
determining a manner of processing a second set of data associated with the first machine learning model based on comparing the first embedding generated by the first machine learning model with the first set of data; and
processing the second set of data according to the manner of processing the second set of data.

Clause 6: The method of Clause 5, further comprising:
receiving, from a computing device, an input, wherein the second set of data is based on the input, and wherein processing the second set of data comprises filtering the input to obtain a filtered input; and
providing the filtered input to the computing system.

Clause 7: The method of Clause 5, further comprising:
receiving, from the computing system, an output, wherein the second set of data is based on the output, and wherein processing the second set of data comprises filtering the output obtain a filtered output; and
providing the filtered output to a computing device.

Clause 8: The method of Clause 5, further comprising:
receiving, from the computing system, an output, wherein the second set of data is based on the output, and wherein processing the second set of data comprises dropping the output.

Clause 9: The method of Clause 5, further comprising:
instructing termination of implementation of the first machine learning model based on the manner of processing the second set of data.

Clause 10: The method of Clause 5, further comprising:
routing the second set of data to a data destination based on the manner of processing the second set of data, wherein the data destination comprises the computing system or a user computing device.

Clause 11: The method of Clause 5, further comprising:
determining a task associated with the first machine learning model; and
determining a relevance of the first embedding generated by the first machine learning model to the task associated with the first machine learning model based on comparing the first embedding generated by the first machine learning model with the first set of data, wherein determining the manner of processing the second set of data is further based on the relevance of the first embedding generated by the first machine learning model to the task.

Clause 12: The method of Clause 5, further comprising:
identifying a second embedding generated by the first machine learning model, wherein the first embedding and the second embedding are generated by different embedding models of the first machine learning model; and
comparing the second embedding generated by the first machine learning model with the first set of data, wherein determining the manner of processing the second set of data is further based on comparing the second embedding generated by the first machine learning model with the first set of data.

Clause 13: The method of Clause 5, wherein the first set of data comprises a second embedding, and wherein comparing the first embedding generated by the first machine learning model with the first set of data comprises:
performing a vector similarity search based on the first embedding and the second embedding.

Clause 14: The method of Clause 5, further comprising:
comparing a difference between the first embedding generated by the first machine learning model and the first set of data to a threshold, wherein determining the manner of processing the second set of data is further based on comparing the difference between the first embedding generated by the first machine learning model and the first set of data to the threshold.

Clause 15: The method of Clause 5, wherein the first set of data comprises a first set of anomalous data associated with the first machine learning model and a second set of non-anomalous data associated with the first machine learning model.

Clause 16: The method of Clause 5, wherein the first machine learning model comprises a first version of an embedding model, the method further comprising:
providing the second set of data to a second computing system, wherein the second computing system implements a second machine learning model, and wherein the second machine learning model comprises a second version of the embedding model.

Clause 17: One or more non-transitory computer-readable media including computer-executable instructions, wherein execution of the computer-executable instructions by a computing system including a processor causes the computing system to:
identify a first embedding generated by a machine learning model;
obtain, from a data store, a first set of data associated with the machine learning model;
compare the first embedding generated by the machine learning model with the first set of data;
determine a manner of processing a second set of data associated with the machine learning model based on comparing the first embedding generated by the machine learning model with the first set of data; and
process the second set of data according to the manner of processing the second set of data.

Clause 18: The one or more non-transitory computer-readable media of Clause 17, wherein the execution of the computer-executable instructions by the computing system further causes the computing system to:
output a prompt for the machine learning model, wherein the prompt comprises one or more of a prompt to generate anomalous outputs or a prompt to generate non-anomalous outputs;
obtain an output based on the prompt; and
store the output in the data store, wherein the first set of data is based on the output.

Clause 19: The one or more non-transitory computer-readable media of Clause 17, wherein the execution of the computer-executable instructions by the computing system further causes the computing system to:
generate an alert based on the manner of processing the second set of data, wherein the alert indicates one or more of a similarity or a reliability associated with the second set of data; and
cause display of the alert.

Clause 20: The one or more non-transitory computer-readable media of Clause 17, wherein the machine learning model comprises a text-based machine learning model, an audio-based machine learning model, or an image-based machine learning model, and wherein a prompt for the machine learning model is based on one or more of text data, audio data, or image data.

Clause 21: The one or more non-transitory computer-readable media of Clause 17, wherein to determine the manner of processing the second set of data, the execution of the computer-executable instructions by the computing system further causes the computing system to:
identify a vector generated by the machine learning model, wherein the vector is associated with an attention mechanism of the machine learning model;
compare the vector to one or more vectors; and
determine the manner of processing the second set of data further based on comparing the vector to the one or more vectors.

Various example embodiments of the disclosure can be described by the following clauses:

Clause 1: A system comprising:
data processing hardware; and
memory in communication with the data processing hardware, the memory storing instructions, wherein execution of the instructions by the data processing hardware causes the data processing hardware to:
   obtain, from a user computing device, an input, wherein the input comprises a request to generate an output using a machine learning model;
   provide, to a computing system, a prompt for a machine learning model, wherein the computing system implements the machine learning model according to the prompt and first contextual data associated with the machine learning model;
   obtain, in real time, a first data unit of a data stream, wherein the machine learning model generates the data stream as part of an inference process of the machine learning model based on implementation of the machine learning model according to the prompt and the first contextual data;
   determine that the first data unit satisfies one or more first parameters associated with adjustment of the first contextual data, wherein the one or more first parameters are based on one or more of a difference in contextual data, a time period, a number of data units, or data included within a particular data unit;
   obtain, from a data store external to the system, second contextual data associated with the first data unit based on determining that the first data unit satisfies the one or more first parameters;
   provide, to the computing system, the second contextual data;
   obtain, from the computing system, the output based on the second contextual data and filtered first contextual data, wherein the first contextual data is filtered to obtain the filtered first contextual data; and
   provide, to the user computing device, the output based on obtaining the input.

Clause 2: The system of Clause 1, wherein the machine learning model generates the output based on the prompt and the data stream, and wherein the data stream is separate and distinct from the output.

Clause 3: The system of Clause 1, wherein the execution of the instructions by the data processing hardware further causes the data processing hardware to:
determine a likelihood of a second data unit of the data stream satisfying the one or more first parameters in response to determining that the first data unit satisfies the one or more first parameters; and
determine that the likelihood satisfies a threshold to identify a predicted future need for the second contextual data;

wherein to provide the second contextual data, the execution of the instructions by the data processing hardware further causes the data processing hardware to:
provide the second contextual data based on determining that the likelihood satisfies the threshold.

Clause 4: The system of Clause 1, wherein the execution of the instructions by the data processing hardware further causes the data processing hardware to:
update, using reinforcement learning, the one or more first parameters based on the output.

Clause 5: A method comprising:
providing, to a computing system, a prompt for a machine learning model, wherein the computing system implements the machine learning model;
identifying a first token generated by the machine learning model based on first contextual data associated with the machine learning model, wherein the machine learning model generates the first token as part of an inference process;
determining that the first token satisfies one or more first parameters, wherein the one or more first parameters are based on one or more of a difference in contextual data, a time period, a number of tokens, or data included within a particular token;
obtaining, from a data store, second contextual data associated with the first token based on determining that the first token satisfies the one or more first parameters; and
providing, to the computing system, the second contextual data, wherein the machine learning model generates an output based on the second contextual data and filtered first contextual data, wherein the first contextual data is filtered to obtain the filtered first contextual data.

Clause 6: The method of Clause 5, wherein the one or more first parameters indicate one or more of a term, a modification to semantics, a modification to complexity, or a background condition, wherein determining that the first token satisfies the one or more first parameters comprises determining that data included within the first token indicates the term, the modification to the semantics, the modification to the complexity, or the background condition indicated by the one or more first parameters.

Clause 7: The method of Clause 5, wherein the one or more first parameters indicate the time period, wherein determining that the first token satisfies the one or more first parameters comprises determining that a time period associated with the inference process satisfies the time period indicated by the one or more first parameters.

Clause 8: The method of Clause 5, wherein the one or more first parameters indicate the number of tokens, wherein determining that the first token satisfies the one or more first parameters comprises determining that a number of tokens generated by the machine learning model satisfies the number of tokens indicated by the one or more first parameters.

Clause 9: The method of Clause 5, wherein the one or more first parameters indicate the difference in contextual data, wherein determining that the first token satisfies the one or more first parameters comprises determining that a difference between the first contextual data and third contextual data satisfies the difference in contextual data indicated by the one or more first parameters.

Clause 10: The method of Clause 5, wherein the prompt comprises one or more of a request to generate code, a request to answer a question, or a request to perform logical reasoning.

Clause 11: The method of Clause 5, further comprising:
identifying a second token generated by the machine learning model, wherein determining that the first token satisfies the one or more first parameters comprises determining that one or more of the first token or the second token satisfies the one or more first parameters, and wherein the second contextual data is associated with the one or more of the first token or the second token.

Clause 12: The method of Clause 5, further comprising:
obtaining, from a user computing device, an input, wherein the input comprises a request to generate the output using the machine learning model;
determining that at least a portion of the input satisfies one or more second parameters;
obtaining, from the data store, a second set of data associated with the at least a portion of the input based on determining that the at least a portion of the input satisfies the one or more second parameters; and
generating the prompt based on the input and the second set of data.

Clause 13: The method of Clause 5, wherein the machine learning model generates the first token based on the first contextual data, and wherein the machine learning model generates a second token based on the second contextual data and the filtered first contextual data.

Clause 14: The method of Clause 5, wherein the machine learning model comprises a text-based machine learning model, an audio-based machine learning model, or an image-based machine learning model, wherein the prompt is based on one or more of text data, audio data, or image data, wherein the first contextual data comprises textual data, and wherein the second contextual data comprises non-textual data, the method further comprising:
combining the textual data and the non-textual data to obtain combined data, wherein providing the second contextual data comprises providing the combined data.

Clause 15: The method of Clause 5, further comprising:
adjusting one or more weights of an input to the machine learning model based on the second contextual data;
identifying a position within the input, the position corresponding to a semantic boundary;
injecting the second contextual data at the position; and
providing the input to the machine learning model.

Clause 16: The method of Clause 5, wherein determining that the first token satisfies the one or more first parameters comprises:
determining that the first token satisfies at least two of the difference in contextual data, the time period, the number of tokens, or the data included within the particular token.

Clause 17: The method of Clause 5, further comprising:
identifying an input for the machine learning model;
identifying a position for the second contextual data within the input; and
generating an adjusted input based on insertion of the second contextual data into the input at the position, wherein providing the second contextual data comprises providing the adjusted input.

Clause 18: One or more non-transitory computer-readable media including computer-executable instructions, wherein execution of the computer-executable instructions by a computing system including a processor causes the computing system to:
identify one or more tokens generated by a machine learning model based on first contextual data associated with the machine learning model, wherein the machine learning model generates the one or more tokens as part of an inference process;
determine that the one or more tokens satisfy one or more first parameters, wherein the one or more first parameters are based on one or more of a difference in contextual data, a time period, a number of tokens, or data included within a particular token;
obtain, from a data store, second contextual data associated with the one or more tokens based on determining that the one or more tokens satisfy the one or more first parameters; and
provide, to the machine learning model, the second contextual data, wherein the machine learning model generates an output based on the second contextual data and filtered first contextual data, wherein the first contextual data is filtered to obtain the filtered first contextual data.

Clause 19: The one or more non-transitory computer-readable media of Clause 18, wherein the execution of the computer-executable instructions by the computing system further causes the computing system to:
generate a query based on determining that the one or more tokens satisfy the one or more first parameters, wherein to obtain the second contextual data, the execution of the computer-executable instructions by the computing system further causes the computing system to obtain the second contextual data based on execution of the query.

Clause 20: The one or more non-transitory computer-readable media of Clause 18, wherein the execution of the computer-executable instructions by the computing system further causes the computing system to:
identify a conflict between the first contextual data and the second contextual data; and
filter the first contextual data based on identifying the conflict between the first contextual data and the second contextual data to obtain the filtered first contextual data, wherein filtering the first contextual data is further based on at least one of a time period, a source, or an uncertainty associated with at least one of the first contextual data or the second contextual data.

Clause 21: The one or more non-transitory computer-readable media of Clause 18, wherein the execution of the computer-executable instructions by the computing system further causes the computing system to:
filter the first contextual data based on a difference between the one or more tokens and the first contextual data to obtain the filtered first contextual data.

Clause 22: The one or more non-transitory computer-readable media of Clause 18, wherein the execution of the computer-executable instructions by the computing system further causes the computing system to:
filter third contextual data to obtain the second contextual data and remove private contextual data from the third contextual data based on one or more first tags associated with a user and one or more second tags associated with the third contextual data.

Clause 23: The one or more non-transitory computer-readable media of Clause 18, wherein the execution of the computer-executable instructions by the computing system further causes the computing system to:
score the second contextual data and the first contextual data to obtain scored contextual data, wherein the machine learning model further generates the output based on the scored contextual data.

Clause 24: The one or more non-transitory computer-readable media of Clause 18, wherein the execution of the computer-executable instructions by the computing system further causes the computing system to:
identify one or more probabilities associated with the one or more tokens and generated by the machine learning model, wherein to identify the one or more tokens, the execution of the computer-executable instructions by the computing system further causes the computing system to identify the one or more tokens based on the one or more probabilities.

Various example embodiments of the disclosure can be described by the following clauses:

Clause 1: A system comprising:
data processing hardware; and
memory in communication with the data processing hardware, the memory storing instructions, wherein execution of the instructions by the data processing hardware causes the data processing hardware to:
   identify data associated with a machine learning model, wherein the data is associated with one or more first tags, and wherein the data comprises an output of the machine learning model or an input to the machine learning model;
   determine that the data satisfies one or more parameters;
   obtain, from a data store that is external to the system, contextual data based on determining that the data satisfies one or more parameters, wherein the contextual data is associated with one or more second tags, and wherein the contextual data is associated with the data;
   compare the one or more first tags with the one or more second tags;
   identify at least a portion of the contextual data based on comparing the one or more first tags with the one or more second tags, wherein the at least a portion of the contextual data comprises private data, wherein at least a portion of the one or more second tags are associated with the at least a portion of the contextual data, and wherein the at least a portion of the one or more second tags are different from the one or more first tags;
   filter the contextual data to remove the at least a portion of the contextual data and obtain filtered contextual data; and
   provide, to the machine learning model, the filtered contextual data, wherein the machine learning model generates an output based on the filtered contextual data.

Clause 2: The system of Clause 1, wherein the data is generated by the machine learning model during an inference process of the machine learning model or a training process of the machine learning model, wherein the execution of the instructions by the data processing hardware further causes the data processing hardware to:
obtain the output from the machine learning model; and
route the output to a user computing device.

Clause 3: The system of Clause 1, wherein the execution of the instructions by the data processing hardware further causes the data processing hardware to:
update, using reinforcement learning, the one or more parameters based on an output of the machine learning model.

Clause 4: The system of Clause 1, wherein the execution of the instructions by the data processing hardware further causes the data processing hardware to:
identify a need for the contextual data based on determining that the data satisfies the one or more parameters.

Clause 5: A method comprising:
identifying data associated with a machine learning model, wherein the data is associated with one or more first tags;
determining that the data satisfies one or more parameters;
obtaining contextual data based on determining that the data satisfies one or more parameters, wherein the contextual data is associated with one or more second tags;
comparing the one or more first tags with the one or more second tags;
obtaining filtered contextual data based on comparing the one or more first tags with the one or more second tags; and
providing, to the machine learning model, the filtered contextual data, wherein the machine learning model generates an output based on the filtered contextual data.

Clause 6: The method of Clause 5, wherein identifying the data comprises:
identifying a token generated by the machine learning model, wherein the data comprises the token; or
identifying an input to the machine learning model, wherein the data comprises the input.

Clause 7: The method of Clause 5, further comprising:
obtaining, from a data store, the one or more first tags based on identifying the data.

Clause 8: The method of Clause 5, further comprising:
identifying a need for the contextual data based on determining that the data satisfies the one or more parameters, wherein the contextual data provides context relative to the data; and
filtering the contextual data based on comparing the one or more first tags with the one or more second tags.

Clause 9: The method of Clause 5, further comprising:
obtaining, from a user computing device, an input to the machine learning model, wherein the data is based on the input, and wherein the one or more first tags indicate at least one of the user computing device, a user associated with the user computing device, an organization associated with the user computing device, or a clearance level associated with the user computing device.

Clause 10: The method of Clause 5, further comprising:
generating the one or more second tags based on obtaining the contextual data, wherein the one or more second tags indicate at least one of a subject of the contextual data, a source of the contextual data, an organization associated with the contextual data, or a clearance level associated with the contextual data.

Clause 11: The method of Clause 5, wherein obtaining the filtered contextual data comprises:
filtering the contextual data to remove a first portion of the contextual data, wherein the filtered contextual data comprises a second portion of the contextual data.

Clause 12: The method of Clause 5, further comprising:
determining a first portion of the contextual data is associated with a first portion of the one or more second tags, wherein the first portion of the one or more second tags are different from the one or more first tags; and
determining a second portion of the contextual data is associated with a second portion of the one or more second tags, wherein the one or more first tags comprise the second portion of the one or more second tags; and

wherein obtaining the filtered contextual data comprises:
filtering the contextual data to remove the first portion of the contextual data based on determining the first portion of the contextual data is associated with the first portion of the one or more second tags and determining the second portion of the contextual data is associated with the second portion of the one or more second tags, wherein the filtered contextual data comprises the second portion of the contextual data.

Clause 13: The method of Clause 5, wherein the one or more parameters indicate one or more of a term, a modification to semantics, a modification to complexity, or a background condition, wherein determining that the data satisfies the one or more parameters comprises determining that the data indicates the term, the modification to the semantics, the modification to the complexity, or the background condition indicated by the one or more parameters.

Clause 14: The method of Clause 5, wherein the one or more parameters indicate a time period, wherein determining that the data satisfies the one or more parameters comprises determining that a time period associated with the machine learning model satisfies the time period indicated by the one or more parameters.

Clause 15: The method of Clause 5, wherein the one or more parameters indicate a number of tokens, wherein determining that the data satisfies the one or more parameters comprises determining that a number of tokens generated by the machine learning model satisfies the number of tokens indicated by the one or more parameters.

Clause 16: The method of Clause 5, wherein the one or more parameters indicate a difference in contextual data, wherein determining that the data satisfies the one or more parameters comprises determining that a difference between the contextual data and second contextual data satisfies the difference in contextual data indicated by the one or more parameters.

Clause 17: The method of Clause 5, wherein the machine learning model comprises a text-based machine learning model, an audio-based machine learning model, or an image-based machine learning model, wherein a prompt to the machine learning model is based on one or more of text data, audio data, or image data, and wherein the contextual data comprises at least one of textual data or non-textual data.

Clause 18: One or more non-transitory computer-readable media including computer-executable instructions, wherein execution of the computer-executable instructions by a computing system including a processor causes the computing system to:
identify data associated with a machine learning model, wherein the data is associated with one or more first identifiers;
determine that the data satisfies one or more parameters;
in response to determining that the data satisfies one or more parameters, obtain filtered contextual data based on the one or more first identifiers and one or more second identifiers, wherein the one or more second identifiers are associated with the filtered contextual data; and
provide, to the machine learning model, the filtered contextual data, wherein the machine learning model generates an output based on the filtered contextual data.

Clause 19: The one or more non-transitory computer-readable media of Clause 18, wherein the execution of the computer-executable instructions by the computing system further causes the computing system to:
obtain, from a data store external to the computing system, contextual data; and
filter the contextual data based on the one or more first identifiers and the one or more second identifiers.

Clause 20: The one or more non-transitory computer-readable media of Clause 18, wherein the execution of the computer-executable instructions by the computing system further causes the computing system to:
compare the one or more first identifiers with the one or more second identifiers, wherein to obtain the filtered contextual data, the execution of the computer-executable instructions by the computing system further causes the computing system to:
obtain the filtered contextual data further based on comparing the one or more first identifiers with the one or more second identifiers.

What is claimed is:

1. A computing system comprising:
data processing hardware; and
memory in communication with the data processing hardware, the memory storing instructions, wherein execution of the instructions by the data processing hardware causes the data processing hardware to:
obtain, from a user computing device, a first input, wherein the first input comprises a request to generate an output using a machine learning model;
obtain, from a data store, a set of data based on obtaining the first input, wherein the set of data comprises one or more vector embeddings of anomalous data associated with the machine learning model;
generate, using an embedding model, a first vector embedding of the first input;
compare, using a vector search, the first vector embedding and the one or more vector embeddings;
determine a manner of processing the first input based on comparing the first vector embedding and the one or more vector embeddings, wherein the manner of processing the first input indicates to drop the first input, route the first input to a first destination, or filter the first input;
route the first input to the machine learning model based on the manner of processing the first input;
obtain a first output of the machine learning model based on routing the first input to the machine learning model;
generate, using the embedding model, a second vector embedding of the first output;
compare, using the vector search, the second vector embedding and the one or more vector embeddings;
determine a manner of processing the first output based on comparing the first vector embedding and the one or more vector embeddings, wherein the manner of processing the first output indicates to drop the first output, route the first output to a second destination, or filter the first output; and
process the first output according to the manner of processing the first output.

2. The computing system of claim 1, wherein the execution of the instructions by the data processing hardware further causes the data processing hardware to:
obtain a second input;
generate, using the embedding model, a second vector embedding of the second input;
compare the second vector embedding and the one or more vector embeddings;
determine a manner of processing the second input based on comparing the second vector embedding and the one or more vector embeddings; and
drop the second input based on the manner of processing the second input.

3. The computing system of claim 1, wherein to route the first input, the execution of the instructions by the data processing hardware further causes the data processing hardware to:
route the first input to a second computing system, wherein the second computing system implements the machine learning model, and wherein the machine learning model generates the first output based on the first input.

4. The computing system of claim 1, wherein to compare the first vector embedding and one or more vector embeddings, the execution of the instructions by the data processing hardware further causes the data processing hardware to:
compare the first vector embedding and a third vector embedding of the one or more vector embeddings, and
wherein to compare the second vector embedding and the one or more vector embeddings, the execution of the instructions by the data processing hardware further causes the data processing hardware to:
compare the second vector embedding and a fourth vector embedding of the one or more vector embeddings.

5. A method comprising:
receiving, from a computing system, a first set of data associated with a machine learning model;
generating, using an embedding model, a first embedding of the first set of data based on the first set of data being associated with the machine learning model;
determining a difference between the first embedding and a second set of data stored in a data store;
determining a manner of processing the first set of data based on the difference between the first embedding and the second set of data; and
processing the first set of data according to the manner of processing the first set of data.

6. The method of claim 5, further comprising:
determining a format of the second set of data; and
adjusting a format of the first set of data based on the format of the second set of data to obtain an adjusted first set of data, wherein the first embedding comprises an embedding of the adjusted first set of data.

7. The method of claim 5, further comprising:
receiving, from the computing system, an input, wherein the input comprises a request to generate an output using the machine learning model, and wherein the first set of data is based on the input.

8. The method of claim 5, wherein the computing system implements the machine learning model, and wherein the first set of data comprises an output of the machine learning model.

9. The method of claim 5, wherein determining the difference between the first embedding and the second set of data comprises:
performing a vector similarity search.

10. The method of claim 5, further comprising:
comparing the difference between the first embedding and the second set of data to a threshold, wherein determining the manner of processing the first set of data is further based on comparing the difference between the first embedding and the second set of data to the threshold.

11. The method of claim 5, further comprising:
determining the first set of data represents an anomaly based on the difference between the first embedding and the second set of data,
wherein processing the first set of data comprises one or more of:
dropping the first set of data based on determining the first set of data represents the anomaly;
routing the first set of data to a computing device based on determining the first set of data represents the anomaly; or
generating an alert based on determining the first set of data represents the anomaly.

12. The method of claim 5, wherein processing the first set of data comprises one or more of:
routing the first set of data to the computing system;
routing a prompt based on the first set of data to the computing system; or
routing the first set of data to a computing device.

13. The method of claim 5, further comprising:
receiving, from the computing system, an input;
generating a first prompt for the machine learning model based on the input, wherein the first set of data comprises an output of the machine learning model;
determining the first set of data represents an anomaly based on the difference between the first embedding and the second set of data; and
generating a second prompt for the machine learning model based on determining the first set of data represents the anomaly.

14. The method of claim 5, further comprising:
obtaining a third set of data;
normalizing the third set of data to obtain a normalized third set of data; and
generating a second embedding based on the normalized third set of data, wherein the second set of data comprises the second embedding.

15. The method of claim 5, further comprising:
updating, in real time, the second set of data.

16. One or more non-transitory computer-readable media including computer-executable instructions, wherein execution of the computer-executable instructions by a first computing system including a processor causes the first computing system to:
receive, from a second computing system, a first set of data associated with a machine learning model;
compare a second set of data and a first embedding of the first set of data based on the first set of data being associated with the machine learning model;
determine a manner of processing the first set of data based on comparing the second set of data and the first embedding; and
process the first set of data according to the manner of processing the first set of data.

17. The one or more non-transitory computer-readable media of claim 16, wherein the execution of the computer-executable instructions by the first computing system further causes the first computing system to:
obtain, from a data store, the second set of data, wherein the second set of data comprises anomalous data.

18. The one or more non-transitory computer-readable media of claim 16, wherein the machine learning model comprises a text-based machine learning model, an audio-based machine learning model, or an image-based machine learning model, and wherein the second set of data is based on two or more of text data, audio data, or image data.

19. The one or more non-transitory computer-readable media of claim 16, wherein the first set of data comprises one or more of an input to the machine learning model or an output of the machine learning model.

20. The one or more non-transitory computer-readable media of claim 16, wherein the execution of the computer-executable instructions by the first computing system further causes the first computing system to:
receive a request to moderate one or more of an input to the machine learning model or an output of the machine learning model, wherein the manner of processing the first set of data is based on the request.
